(19) United States
(12) Patent Application Publication
(10) Pub. No.: US 2012/0005426 A1
(43) Pub. Date: Jan. 5, 2012

(54) STORAGE DEVICE, CONTROLLER OF STORAGE DEVICE, AND CONTROL METHOD OF STORAGE DEVICE

(75) Inventors: Akira SAMPEI, Kawasaki (JP); Fumio Hanzawa, Kawasaki (JP); Hiroaki Sato, Kawasaki (JP)

(73) Assignee: Fujitsu Limited, Kawasaki (JP)

(21) Appl. No.: 13/090,758

(22) Filed: Apr. 20, 2011

(30) Foreign Application Priority Data
Jul. 1, 2010 (JP) 2010-151464

(51) Int. Cl. G06F 12/08

(52) U.S. Cl. 711/114; 711/E12.019

(57) ABSTRACT

A storage device includes a plurality of data storage units that store data; an attribution storage unit that stores an attribution group including each data storage unit on the basis of attributions of the plurality of data storage units; a defect storage unit that stores defects that occurred in a data storage unit; and a preventive-maintenance-subject extracting unit that extracts, as a preventive-maintenance subject, another data storage unit belonging to the same attribution group as the data storage unit in which the defects stored by the defect storage unit has occurred, on the basis of an occurrence history of the defects that occurred in the data storage unit and the attribution group stored by the attribution group storage unit. The storage device also includes a preventive-maintenance performing unit that performs preventive-maintenance on data stored in the other data storage unit extracted by the preventive-maintenance-subject extracting unit.

### CROSS-REFERENCE TO RELATED APPLICATION

This application is based upon and claims the benefit of priority of the prior Japanese Patent Application No. 2010-151464, filed on Jul. 1, 2010, the entire contents of which are incorporated herein by reference.

### FIELD

The embodiments discussed herein are directed to a storage device, a controller of a storage device, and a control method of a storage device.

### BACKGROUND

Recently, for the purpose of improving the reliability of a storage device, a Redundant Array of Independent Disks (RAID) technology has been wide spread. In general, an RAID storage device contains a number of disks manufactured in the same factory during the same period. For this case, if one disk in the storage device malfunctions, it is anticipated that other disks manufactured during the same period are likely to malfunction due to the same problem.

The recovery of data of the faulty disk requires a mechanism for specifying the timing to replace the faulty disk. For example, there is a technique in which points with an error, in a faulty disk with errors occurred therein, are counted and the disk is replaced with a new one when the number of points reaches or exceeds a threshold value.

An related-art exemplary method of determining the replacement timing of a faulty disk will be described with reference to FIG. 29. FIG. 29 is a view illustrating an example of the timing to replace a faulty disk according to the related art. As illustrated in FIG. 29, a horizontal axis refers to a time axis and a vertical axis refers to a disk name. As for a disk with a name of DISK0, after a first recovered error occurs, second and third recovered errors occur as time passes. In the case of the disk where a threshold value for the number of error occurrences is 4, when a fourth recovered error occurs in the disk DISK0, the total number of the error occurrences of the disk reaches the threshold value. Therefore, the recovery of data of the disk DISK0 is performed. That is, the data of the disk DISK0 is written into a hot spare disk and then the disk DISK0 is replaced with the hot spare disk. As such, the data of the disk DISK0 is recovered. Here, the recovered errors refer to errors which are recoverable through the recovery operation when the errors occur in the disk.

However, there are cases where a non-recoverable error (hereinafter also referred to as “an unrecovered error”) occurs after the occurrence of a recovered error in a disk of a storage device using the RAID technology. In these cases, the same kind of errors as those occurred in the faulty disk are likely to occur in other disks manufactured during the same period as that of the faulty disk in which the unrecovered error has occurred. Therefore, under the condition of being equal to or in excess of the redundancy of the RAID, other disks manufactured during the same period as that of the faulty disk are likely to be discarded together with the faulty disk when the unrecovered errors of the faulty disk occur, so that data in such disks may not be recovered.

Here, a case where data of a disk cannot be recovered will be described with reference to FIG. 30. FIG. 30 is a view illustrating a case where data cannot be recovered. As illustrated in FIG. 30, a horizontal axis refers to a time axis, and a vertical axis refers to disk names. A disk with a name of DISK0 may be in the following circumstances. That is, in the disk, a first recovered error occurs. After a lapse of time, a second recovered error occurs. After that, an unrecovered error occurs at the third time, and thus the disk is one step ahead of the threshold value or more. In this state, the disk DISK0 is cut off. Meanwhile, for a disk DISK1 manufactured during the same period as that of the disk DISK0, it is assumed that a first recovered error occurs at the almost same time as that of the disk DISK0, a second recovered error occurs as time passes, then an unrecovered error occurs at the third time, which means the disk DISK1 is one step ahead of the threshold value or more, and DISK1 is cut off.

In this case, if the disks DISK0 and DISK1 are components of an RAID storage device RAID1, since both of the disks have malfunctioned, data are lost, that is, the data can not be recovered. That is, the data of the disk DISK1 manufactured during the same period as that of the faulty disk DISK0 cannot be recovered under the condition of being equal to or in excess of the redundancy of RAID.

The problem does not limitedly occur in disks manufactured in the same factory during the same period, but may similarly occur in general disks with the same attribution where malfunctions occur due to the same problem.
Patent Document 1: Japanese Laid-open Patent Publication No. 2009-205316
Patent Document 2: Japanese Laid-open Patent Publication No. 2004-118397

### SUMMARY

According to an aspect of an embodiment of the invention, a storage device includes a plurality of data storage units that store data; an attribution storage unit that stores an attribution group including each data storage unit on the basis of attributions of the plurality of data storage units; a defect storage unit that stores defects that occurred in a data storage unit; a preventive-maintenance-subject extracting unit that extracts, as a preventive-maintenance subject, another data storage unit belonging to the same attribution group as the data storage unit in which the defects stored by the defect storage unit has occurred, on the basis of an occurrence history of the defects that occurred in the data storage unit and the attribution group stored by the attribution group storage unit; and a preventive-maintenance performing unit that performs preventive-maintenance on data stored in the other data storage unit extracted by the preventive-maintenance-subject extracting unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a functional block diagram illustrating a configuration of a storage device according to a first embodiment;

FIG. 2 is a functional block diagram illustrating a configuration of a RAID device according to a second embodiment;

FIG. 3 is a functional block diagram illustrating a configuration of a RAID controller of the RAID device according to the second embodiment;

FIG. 4 is a view illustrating an example of a data structure of a lot group table;

FIG. 5 is a view illustrating an example of a data structure of a defect occurrence history table;

FIG. 6 is a view illustrating an example of a data structure of a preventive-maintenance acceleration table;

FIG. 7 is a view illustrating an example of a preventive-maintenance acceleration process according to the second embodiment;

FIG. 8 is a view illustrating changes in point values of the defect occurrence history table according to the second embodiment;

FIG. 9 is a flowchart illustrating a process procedure of grouping according to the second embodiment;

FIG. 10 is a flowchart illustrating a process procedure when a recovered error has occurred in a disk according to the second embodiment;

FIG. 11 is a flowchart illustrating a process procedure when an unrecovered error has occurred in a disk according to the second embodiment;

FIG. 12 is a functional block diagram illustrating a configuration of a RAID controller of a RAID device according to a third embodiment;

FIG. 13 is a view illustrating an example of a data structure of a defect occurrence history table;

FIG. 14 is a view illustrating an example of a data structure of an upper-limit-number-of-recovery-times table;

FIG. 15 is a view illustrating an example of a preventive-maintenance acceleration process according to the third embodiment;

FIG. 16 is a view illustrating changes in the numbers of recovered error times in the defect occurrence history table according to the third embodiment;

FIG. 17 is a flowchart illustrating a process procedure when a recovered error has occurred in a disk according to the third embodiment;

FIG. 18 is a flowchart illustrating a process procedure when an unrecovered error has occurred in a disk according to the third embodiment;

FIG. 19 is a functional block diagram illustrating a configuration of a RAID controller of a RAID device according to a fourth embodiment;

FIG. 20 is a view illustrating an example of a data structure of a RAID group table;

FIG. 21 is a view illustrating a specific example of acceleration condition determination;

FIG. 22 is a flowchart illustrating a process procedure when a recovered error has occurred in a disk according to the fourth embodiment;

FIG. 23 is a flowchart illustrating a process procedure when an unrecovered error has occurred in a disk according to the fourth embodiment;

FIG. 24 is a view illustrating a case where an unrecovered error occurs during preventive-maintenance;

FIG. 25 is a functional block diagram illustrating a configuration of a RAID controller of a RAID device according to the fifth embodiment;

FIG. 26 is a flowchart illustrating a process procedure when a recovered error has occurred in a disk according to the fifth embodiment;

FIG. 27 is a flowchart illustrating a process procedure when an unrecovered error has occurred in a disk according to the fifth embodiment;

FIG. 28 is a view illustrating an example of a preventive-maintenance acceleration process according to the fifth embodiment;

FIG. 29 is a view illustrating an example of the replacement timing of a faulty disk according to the related art; and

FIG. 30 is a view illustrating a case where data cannot be recovered.

### DESCRIPTION OF EMBODIMENTS

Preferred embodiments of the present invention will be explained with reference to accompanying drawings. Further, the invention is not limited to the embodiments.

### First Embodiment

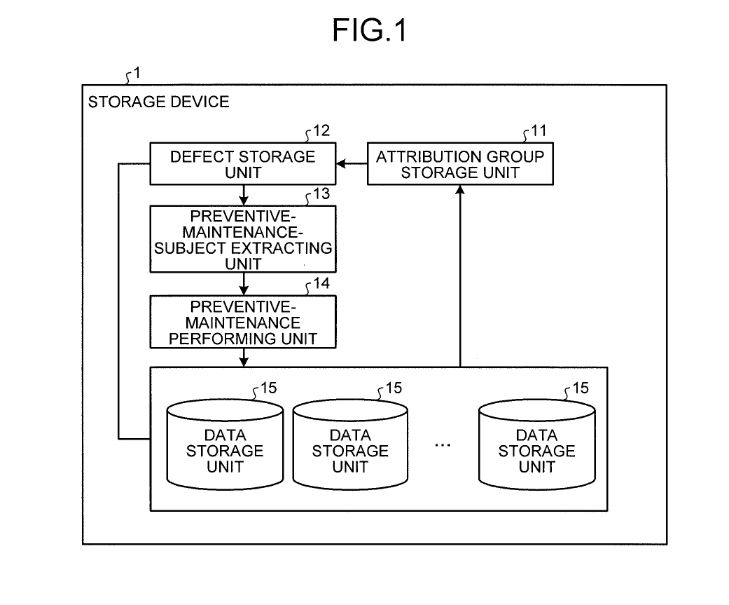

FIG. 1 is a functional block diagram illustrating a configuration of a storage device according to a first embodiment. As illustrated in FIG. 1, a storage device 1 includes an attribution group storage unit 11, a defect storage unit 12, a preventive-maintenance-subject extracting unit 13, a preventive-maintenance performing unit 14, and a plurality of data storage units 15. The data storage units 15 include storage areas storing data.

The attribution group storage unit 11 stores an attribution group to which each of the data storage units 15 belongs, on the basis of the attributions of the plurality of data storage units 15. The defect storage unit 12 stores defects which have occurred in the data storage units 15.

The preventive-maintenance-subject extracting unit 13 extracts, as a preventive-maintenance subject, the data storage unit 15 belonging to the same attribution group as another data storage unit 15 with a defect stored by the defect storage unit 12, on the basis of a history of defects that occurred in the data storage units 15 and the attribution group stored by the attribution group storage unit 11. The preventive-maintenance performing unit 14 performs preventive-maintenance on data stored in the data storage unit 15 extracted by the preventive-maintenance-subject extracting unit 13.

In this way, the storage device 1 extracts, as a preventive-maintenance subject, the data storage unit 15 belonging to the same attribution group with another data storage unit 15 with a defect, and performs preventive-maintenance on the data. Therefore, the storage device 1 can secure the data before a defect occurs in the data storage unit 15 extracted as the preventive-maintenance subject, thereby preventing data loss.

The storage device 1 according to the first embodiment may be a RAID device using the RAID (redundant array of independent disks) technology, and an embodiment thereof will be described below.

### Second Embodiment

### Configuration of Raid Device According to Second Embodiment

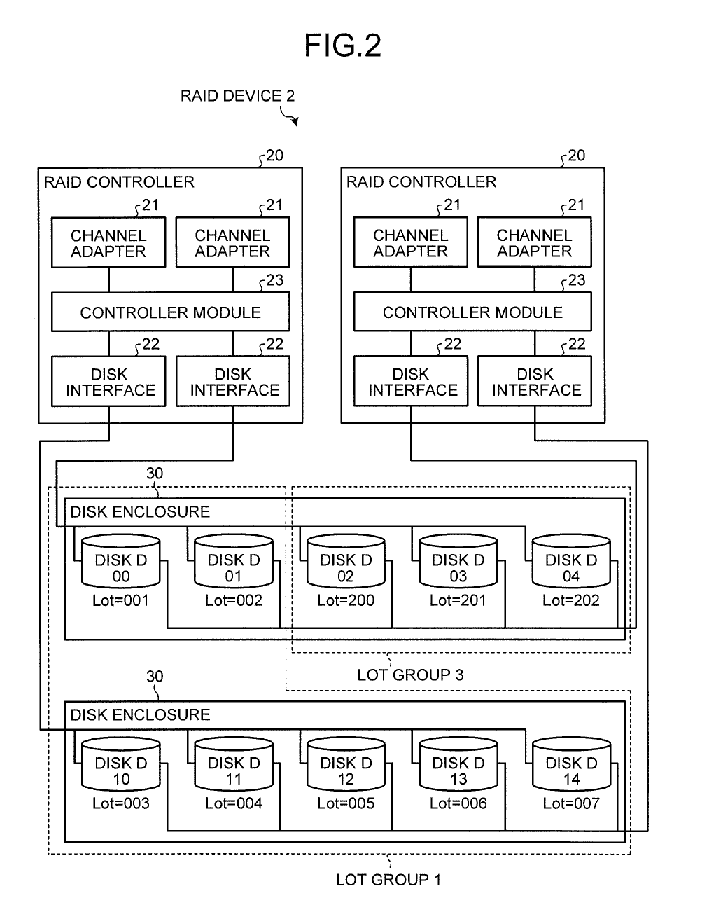

FIG. 2 is a functional block diagram illustrating a configuration of a RAID device 2 according to a second embodiment. As illustrated in FIG. 2, the RAID device 2 includes two RAID controllers 20 and a plurality of disk enclosures 30. The RAID controllers 20 are connected in series to the plurality of disk enclosures 30. The disk enclosures 30 are connected to disks D which function as strange disks, so-called storages. Further, the write and read path of data on all the disks D is duplexed by two RAID controllers 20. For example, two RAID controllers 20 form a hot standby in which one serves as a main system and the other serves as a standby system. Furthermore, although the small-scale RAID device with two RAID controllers 20 is given as an example, the RAID device 2 may be a medium-scale RAID device with four RAID controllers or may be a large-scale RAID device with eight RAID controllers.

In the example of FIG. 2, the disks D are grouped in units of 100 according to lot numbers. That is, disks D00 to D01 and D10 to D14 belong to lot group 1, and disks D02 to D04 belong to lot group 3.

The disks D have predetermined attributions and belong to groups each of which includes disks with the same attribution. The predetermined attributions may include serial numbers (hereinafter, referred to as lot numbers) in a predetermined range consecutively assigned during manufacturing. In general, consecutive lot numbers are assigned to disks D manufactured at the same factory during the same period. Therefore, if one disk malfunctions, there is a possibility that other disks with serial numbers close to the lot number of the faulty disk will also malfunction due to the same type of error. In other words, each group includes disks D which have a possibility of malfunctioning due to a factor based on the same attribution if any one disk D of the disks D malfunctions. Further, although the lot numbers in the predetermined range have been described as an example of the predetermined attribution, for example, the predetermined attribution may be the same maximum rotation speed and may be a feature or a property of the disks D like malfunctioning due to the same kind of error.

The RAID controllers 20 include channel adapters 21, disk interfaces 22, and controller modules 23. The channel adapters 21 are communication interfaces connected to a host (not illustrated) for communication. The disk interfaces 22 are communication interfaces connected to the disks D for communication. The controller modules 23 control the entire RAID controllers 20.

### Configuration of Raid Controller of Raid Device According to Second Embodiment

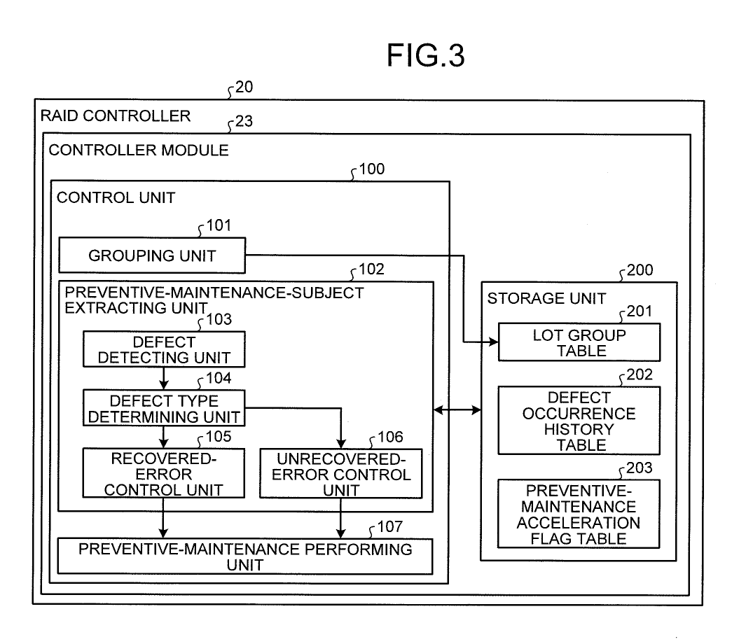

Next, a configuration of the RAID controller 20 will be described with reference to FIG. 3. FIG. 3 is a functional block diagram illustrating a configuration of a RAID controller of the RAID device according to the second embodiment. As illustrated in FIG. 3, the RAID controller 20 includes the controller module 23.

The controller module 23 includes a control unit 100 and a storage unit 200. Further, the control unit 100 includes a grouping unit 101, a preventive-maintenance-subject extracting unit 102, and a preventive-maintenance performing unit 107. Furthermore, the storage unit 200 includes a lot group table 201, a defect occurrence history table 202, and a preventive-maintenance acceleration flag table 203.

The grouping unit 101 groups the disks D on the basis of the lot numbers of the disks D. Specifically, the grouping unit 101 reads the lot number, assigned to each disk D, from the disk D, and determines a lot group corresponding to the read lot number. Then, the grouping unit 101 stores the determined lot group and the lot number in the lot group table 201 to be mapped to each disk D.

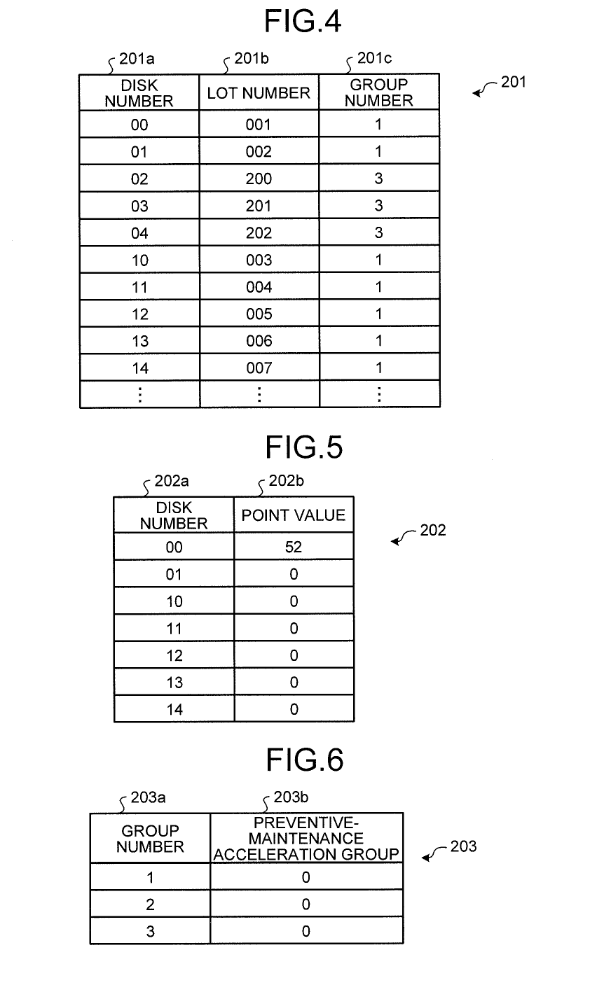

Here, the lot group table 201 will be described with reference to FIG. 4. FIG. 4 is a view illustrating an example of a data structure of the lot group table. As illustrated in FIG. 4, the lot group table 201 stores lot numbers 201b and group numbers 201c to be mapped to the disks D with disk numbers 201a.

The disk numbers 201a are numbers identifying the disks D. For example, the disk numbers 201a are determined on the basis of the disk enclosures 30 by the RAID controller 20 when the RAID device 2 is configured. The lot numbers 201b are numbers of lots uniquely assigned to the individual disks D during manufacturing. The group numbers 201c are numbers of lot groups determined on the basis of the lot numbers 201b. In the example of FIG. 4, the group numbers 201c are defined in units of 100 according to the lot numbers 201b. For example, the group numbers 201c of the disks D with the lot numbers 201b of from “001” to “099” are “1”, and the group numbers 201c of the disks D with the lot numbers 201b of from “200” to “299” are 3.

Returning to FIG. 3, the preventive-maintenance-subject extracting unit 102 extracts, as a preventive-maintenance subject, a disk D belonging to the same lot group with another disk D in which an unrecovered error has occurred, on the basis of the recovered error occurrence history of the disk D and the lot group. Further, the preventive-maintenance-subject extracting unit 102 includes a defect detecting unit 103, a defect type determining unit 104, a recovered-error control unit 105, and an unrecovered-error control unit 106.

The defect detecting unit 103 detects an error that occurred in a disk D. In the error detection, a recovered error or an unrecovered error is a subject. The recovered error means a defect which results from a predetermined factor based on a lot and is recoverable through retries. Further, the unrecovered error means a defect which becomes a factor of immediate cutoff based on a lot and is non-recoverable.

Moreover, in a “preventive-maintenance acceleration process” of the present embodiment, the subject is an unrecovered error that occurred after recovered errors have occurred a predetermined number of times. That is, in the preventive-maintenance acceleration process, in the case where an unrecovered error has occurred after recovered errors occurred a predetermined number of times in one disk, it is determined that there is a possibility that an unrecovered error will occur in the other disks belonging to the same lot group as the disk in which the unrecovered error has occurred by a factor based on the lot. Then, the preventive-maintenance acceleration process is performed so as to accelerate a timing of preventive-maintenance on a disk in which a recovered error has occurred before an unrecovered error occurs.

The defect type determining unit 104 determines the type of the defect detected by the defect detecting unit 103. Specifically, the defect type determining unit 104 determines whether the defect detected by the defect detecting unit 103 is a recovered error or an unrecovered error.

In the case where the defect type determining unit 104 determines that the defect is a recovered error, the recovered-error control unit 105 performs a recovered-error process. Specifically, the recovered-error control unit 105 reads the lot group including the error disk D in which the recovered error has occurred, on the basis of the lot group table 201. Further, in the case where a preventive-maintenance acceleration flag of the read lot group is not “ON”, the recovered-error control unit 105 adds a normal value to a point value representing a recovered-error occurrence history with respect to the error disk D. Furthermore, in the case where the preventive-maintenance acceleration flag of the read lot group is “ON”, the recovered-error control unit 105 adds an acceleration value representing a value larger than the normal value to the point value representing the recovered-error occurrence history with respect to the error disk D. The preventive-maintenance flag is stored in the preventive-maintenance acceleration flag table 203 and is set by the unrecovered-error control unit 106 to be described below.

Moreover, the recovered-error control unit 105 stores the added point value of the defect occurrence history table 202 to be mapped to the disk in which the recovered error has occurred. Here, the defect occurrence history table 202 will be described with reference to FIG. 5. FIG. 5 is a view illustrating an example of a data structure of the defect occurrence history table. As illustrated in FIG. 5, the defect occurrence history table 202 stores an point value 202b to be mapped to each disk D with a disk number 202a, the point values 202b representing recovered-error occurrence histories in points. The point value 202b stores a value obtained by adding a predetermined value whenever a recovered error occurs in the disk D denoted by the disk number 202a. The predetermined value is points (a normal value or an acceleration value) determined according to the value of the preventive-maintenance acceleration flag of the lot group including the disk D. Further, the point value 202b is set to an initial value ‘0’ during activation of the RAID device 2.

Returning to FIG. 3, the recovered-error control unit 105 determines whether the point value of the disk D is not less than a threshold value. When it is determined that the point value reaches or exceeds the threshold value, the recovered-error control unit 105 determines that it is the timing of preventive-maintenance, and extracts, as the preventive-maintenance subject, the error disk D in which the recovered error has occurred. Meanwhile, when it is determined that the point value is less than the threshold, the recovered-error control unit 105 determines that the error disk D in which the recovered error has occurred is not a preventive-maintenance subject.

In the case where the defect type determining unit 104 determines that the defect is an unrecovered error, the unrecovered-error control unit 106 performs an unrecovered-error process. Specifically, the unrecovered-error control unit 106 determines whether the unrecovered error of the error disk D determined as the defect by the defect type determining unit 104 has occurred after a recovered error, on the basis of the defect occurrence history table 202. When it is determined that the unrecovered error has occurred after a recovered error, the unrecovered-error control unit 106 reads the lot group including the error disk D in which the unrecovered error has occurred, on the basis of the lot group table 201. Further, in order to accelerate a timing of preventive-maintenance on another disk D belonging to the read lot group, the unrecovered-error control unit 106 stores a value representing “ON” in the preventive-maintenance acceleration flag of the preventive-maintenance acceleration flag table 203 with respect to the corresponding lot group.

Here, the preventive-maintenance acceleration flag table 203 will be described with reference to FIG. 6. FIG. 6 is a view illustrating an example of a data structure of the preventive-maintenance acceleration table. As illustrated in FIG. 6, the preventive-maintenance acceleration flag table 203 stores a preventive-maintenance acceleration flag 203b to be mapped to each group number 203a. The preventive-maintenance acceleration flag 203b is a flag representing whether to accelerate the timing of preventive-maintenance on disks D belonging to the lot group represented by the group number 203a. The preventive-maintenance acceleration flag 203b is set to “1” (ON) representing that the timing of preventive-maintenance is accelerated, or “0” (OFF) representing that the timing of preventive-maintenance is not accelerated, for example.

Returning to FIG. 3, the unrecovered-error control unit 106 determines whether there is a disk D in which a recovered error has already occurred in the same lot group as the error disk D by using the lot group table 201 and the defect occurrence history table 202. Then, in the case where it is determined that there is a disk D in which a recovered error has already occurred, the unrecovered-error control unit 106 updates the point value of the disk D already set in the defect occurrence history table 202 with an acceleration value into which the point value is converted.

Next, the unrecovered-error control unit 106 determines whether the point value of the disk D in which the recovered error has already occurred is not less than the threshold value. Then, in the case where it is determined that the point value is not less than the threshold value, the unrecovered-error control unit 106 extracts the disk in which the recovered error has already occurred, as the preventive-maintenance subject. Meanwhile, in the case where it is determined that the point value is less than the threshold value, the unrecovered-error control unit 106 determines that the disk D is not a preventive-maintenance subject.

The preventive-maintenance performing unit 107 performs preventive-maintenance on data stored in the disk D extracted as the preventive-maintenance subject. For example, the preventive-maintenance performing unit 107 sequentially reads the data from the disk D extracted as the preventive-maintenance subject by the recovered-error control unit 105 or the unrecovered-error control unit 106. Then, the preventive-maintenance performing unit 107 makes a redundant copy of the read data in the hot spare disk. If the redundant copy of all the data is finished, the preventive-maintenance performing unit 107 cuts the disk D, which is the preventive-maintenance subject, off the disk enclosure 30, and connects the hot spare disk to the disk enclosure, thereby replacing the disks. That is, the preventive-maintenance performing unit 107 replaces the disk D extracted as the preventive-maintenance subject with the hot spare disk, thereby protecting the data of the disk D before an uncovered error occurs in the disk D.

### Example of Preventive-Maintenance Acceleration Process According to Second Embodiment

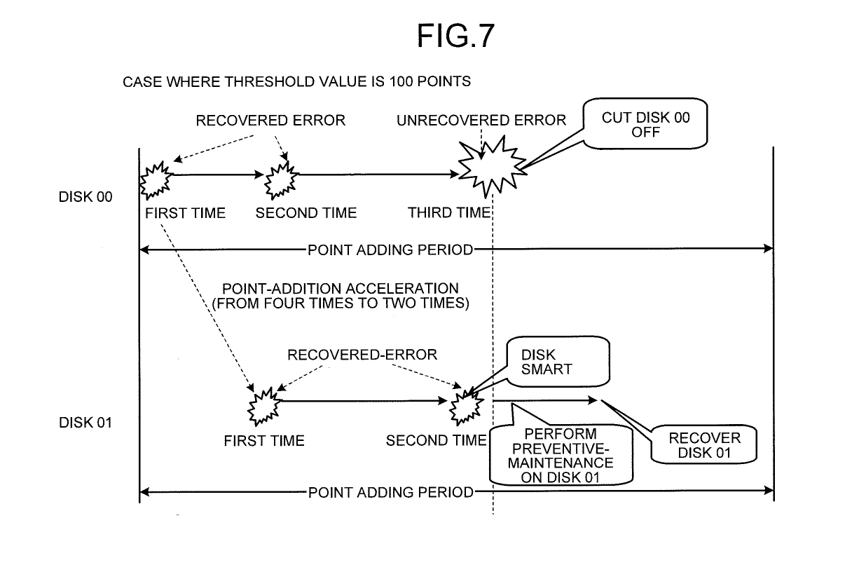

Next, an example of a preventive-maintenance acceleration process according to the second embodiment will be described with reference to FIG. 7. FIG. 7 is a view illustrating an example of the preventive-maintenance acceleration process. As illustrated in FIG. 7, a horizontal axis represents a time axis and a vertical axis represents disk numbers. Further, it is assumed that a disk 00 and a disk 01 illustrated in FIG. 7 belong to the same lot group.

First, with respect to the disk whose disk number is 00, a first recovered error occurs, and a second recovered error occurs as time passes. Meanwhile, after the first recovered error occurs in the disk 00, with respect to the disk whose disk number is 01, a first recovered error occurs, and a second recovered error occurs as time passes. Whenever a recovered error occurs in a disk, the recovered-error control unit 105 adds the normal value to an point value (integrated value) representing a recovered-error occurrence history with respect to the disk D in which the recovered error has occurred.

Then, with respect to the disk 00, an unrecovered error occurs the third time before the added value reaches or exceeds the threshold value, and the unrecovered-error control unit 106 cuts the disk 00 off. At this time, since the disk 01, in which the recovered error has already occurred twice, belongs to the same lot group as the disk 00, the unrecovered-error control unit 106 determines that there is a possibility that an unrecovered error will occur due to a factor based on the lot. Then, the unrecovered-error control unit 106 converts the point value of the disk 01 obtained by adding the normal value whenever the recovered errors have occurred into an acceleration value. Since the converted point value reaches or exceeds the threshold value, the unrecovered-error control unit 106 performs preventive-maintenance on the disk 01 earlier than normal. As a result, with respect to the disk whose disk number is 01, it is possible to prevent an unrecovered error.

### Changes in Point Values of Defect Occurrence History Table According to Second Embodiment

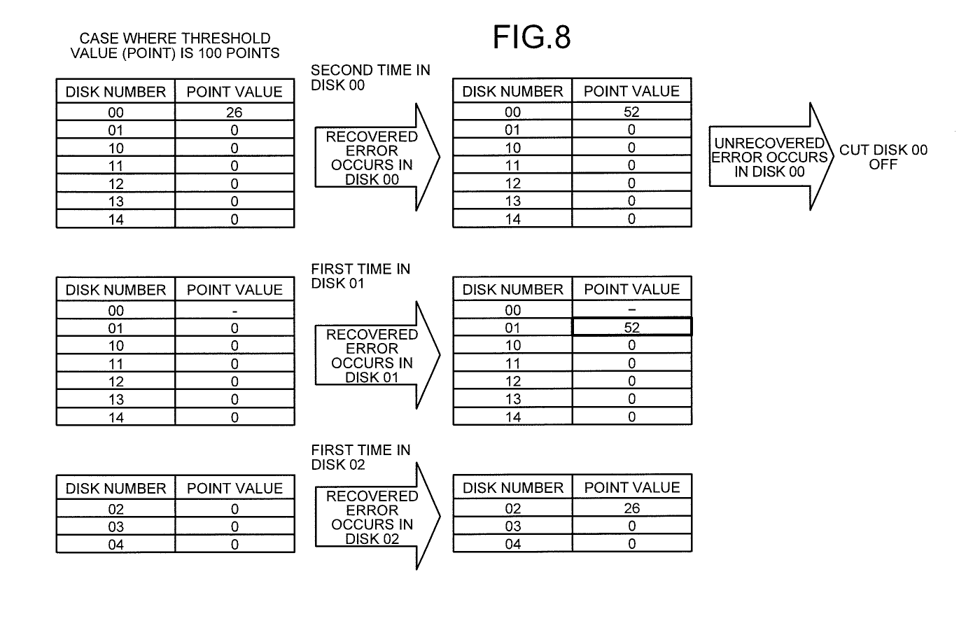

Next, changes in point values of the defect occurrence history table will be described with reference to FIG. 8. FIG. 8 is a view illustrating changes in the point values of the defect occurrence history table according to the second embodiment. Further, it is assumed that the disk 00 and the disk 01 illustrated in FIG. 8 belong to the same lot group, and a disk 02 belongs to a different lot group from the disk 00 and the disk 01. Furthermore, it is assumed that the normal value is 26 points, the acceleration value is 52 points, and the threshold value is 100 points.

As illustrated in FIG. 8, whenever a recovered error occurs in a disk, a value is added to the point value 202b of the disk, in which the recovered error has occurred, in the defect occurrence history table 202. First, with respect to the disk 00, if a first recovered error occurs, the recovered-error control unit 105 adds the normal value (26 points) to the point value 202b of the defect occurrence history table 202, resulting in 26 points. Next, with respect to the disk 00, if a second recovered error occurs, the recovered-error control unit 105 adds the normal value (26 points) to the point value 202b of the defect occurrence history table 202, resulting in 52 points.

Next, with respect to the disk 00, if an unrecovered error occurs, the unrecovered-error control unit 106 cuts off the disk whose disk number is 00 and sets the point value 202b of the defect occurrence history table to a null value. Next, with respect to the disk 01 in the same lot group as the disk 00, if a recovered error occurs, the recovered-error control unit 105 adds the acceleration value (52 points) larger than the normal value to the point value 202b of the defect occurrence history table 202, resulting in 52 points. That is, the recovered-error control unit 105 determines that there is a possibility that an unrecovered error will occur even in the disk 01 in the same lot group as the disk 00 I which the unrecovered error has occurred due to a factor based on the lot, and accelerates the timing of preventive-maintenance.

It is assumed that a recovered error occurs in the disk 02 at the same timing as the disk 01. In this case, since the disk 02 is in the different group from the disk 00, the recovered-error control unit 105 adds the normal value (26 points) to the point value 202b of the defect occurrence history table 202. That is, since the lot group of the disk 02 differs from the lot group of the disk 00 in which the unrecovered error has occurred, the recovered-error control unit 105 determines that the recovered error is not based on the lot and performs a normal process without accelerating the timing of preventive-maintenance.

Further, there is a case where a recovered error already occurred in a disk in the same lot group as the disk 00 in advance when an unrecovered error has occurred in the disk 00. In this case, with respect to the disk, the unrecovered-error control unit 106 updates the point value 202b of the defect occurrence history table 202 with the acceleration value (52 points) into which the point value is converted, whereby the timing of preventive-maintenance is accelerated.

### Process Procedure of Preventive-Maintenance Acceleration Process According to Second Embodiment

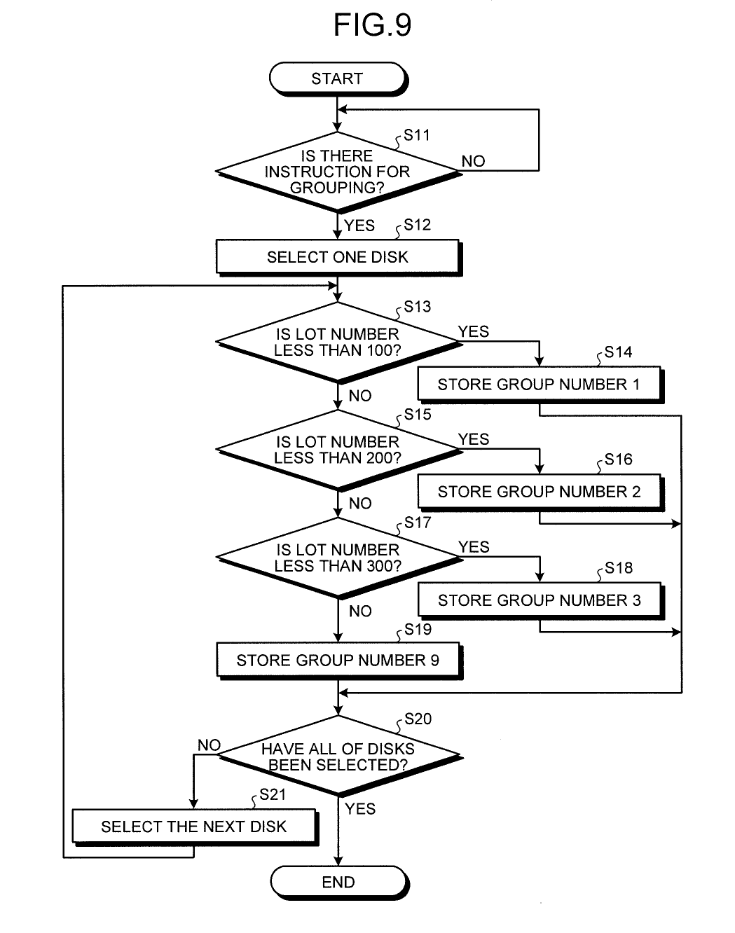

Next, a predetermined procedure of a predetermine-maintenance acceleration process according to the second embodiment will be described with reference to FIGS. 9 to 11. First, a process procedure of grouping will be described with reference to FIG. 9. FIG. 9 is a flowchart illustrating a process procedure of grouping according to the second embodiment.

First, the grouping unit 101 determines whether there is an instruction for grouping based on the lot numbers of disks D (step S11). Then, in the case where there is no instruction for grouping based on the lot numbers of the disks D (No in step S11), the grouping unit 101 proceeds to step S11. Meanwhile, in the case where there is an instruction for grouping based on the lot numbers of the disks D (Yes in step S11), the grouping unit 101 selects one disk D connected to the disk enclosure 30 (step S12).

Subsequently, the grouping unit 101 determines whether the lot number of the selected disk D is less than 100 (step S13). Then, in the case where the lot number of the selected disk D is less than 100 (Yes in step S13), the grouping unit 101 sets the group number representing the number of the low group to “1”. Next, the grouping unit 101 stores the set group number in the lot group table 201 (step S14), and proceeds to step S20.

Meanwhile, in the case where the lot number of the selected disk D is not less than 100 (No in step S13), the grouping unit 101 determines whether the lot number of the selected disk D is less than 200 (step S15). Then, in the case where the lot number of the selected disk D is less than 200 (Yes in step S15), the grouping unit 101 sets the group number to “2”. Next, the grouping unit 101 stores the set group number in the lot group table 201 (step S16), and proceeds to step S20.

Meanwhile, in the case where the lot number of the selected disk D is not less than 200 (No in step S15), the grouping unit 101 determines whether the lot number of the selected disk D is not less than 300 (step S17). Then, in the case where the number of the selected disk D is less than 300 (Yes in step S17), the grouping unit 101 sets the group number to “3”. Next, the grouping unit 101 stores the set group number in the lot group table 201 (step S18), and proceeds to step S20.

Meanwhile, in the case where the lot number of the selected disk D is not less than 300 (No in step S17), the grouping unit 101 sets the group number to “9”, and stores the set group number in the lot group table 201 (step S19). Next, the grouping unit 101 determines whether all of the disks connected to the disk enclosure 30 have been selected (step S20).

Then, when all of the disks D have not been selected (No in step S20), the grouping unit 101 selects the next disk D (step S21). Meanwhile, when all of the disks D have been selected (Yes in step S20), the grouping unit 101 finishes the grouping process.

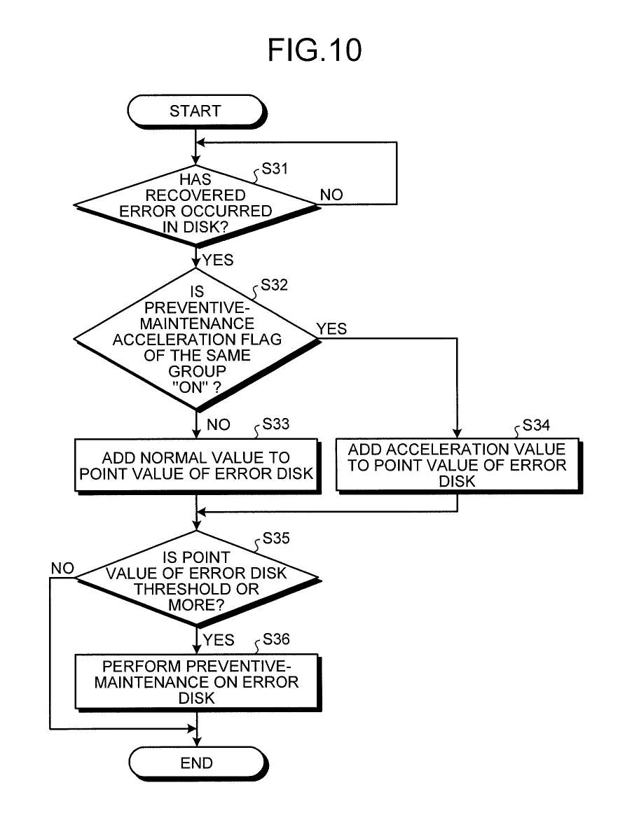

Next, a process procedure when a recovered error has occurred in a disk will be described with reference to FIG. 10. FIG. 10 is a flowchart illustrating a process procedure when a recovered error has occurred in a disk according to the second embodiment. Further, it is assumed that the defect detecting unit 103 has detected that an error occurred in a disk D.

First, the defect type determining unit 104 determines whether the defect detected by the defect detecting unit 103 is a recovered error (step S31). Then, in the case where the defect is not a recovered error (No in step S31), the process procedure proceeds to step S31.

Meanwhile, when the defect is a recovered error (Yes in step S31), the recovered-error control unit 105 determines whether the preventive-maintenance acceleration flag of the lot group including the disk D in which the recovered error has occurred is “ON” (step S32). Specifically, the recovered-error control unit 105 reads the lot group (group number) including the disk D in which the recovered error has occurred, from the lot group table 201. Then, the recovered-error control unit 105 reads the preventive-maintenance acceleration flag mapped to the read group number from the preventive-maintenance acceleration flag table 203, and determines whether the preventive-maintenance acceleration flag is “ON” (for example, “1”).

Subsequently, in the case where the preventive-maintenance acceleration flag of the lot group including the error disk D is not “ON” (No in step S32), the recovered-error control unit 105 adds the normal value to the point value of the error disk D (step S33). Meanwhile, in the case where the preventive-maintenance acceleration flag of the lot group including the error disk D is “ON” (Yes in step S32), the recovered-error control unit 105 adds the acceleration value representing a value larger than the normal value to the point value of the error disk D (step S34). Then, the recovered-error control unit 105 stores the added point value in the defect occurrence history table 202 to be mapped to the error disk D.

Subsequently, the recovered-error control unit 105 determines whether the point value reaches or exceeds the threshold value (step S35). Then, in the case where the point value reaches or exceeds the threshold value (Yes in step S35), the recovered-error control unit 105 determines that it is the timing of preventive-maintenance and extracts the error disk D as the preventive-maintenance subject. Next, the preventive-maintenance performing unit 107 performs preventive-maintenance on data stored in the disk D extracted as the preventive-maintenance subject (step S36), and finishes the process when the recovered error has occurred.

Meanwhile, in the case where the point value of the error disk D is less than the threshold value (No in step S35), the recovered-error control unit 105 determines that the error disk is not a preventive-maintenance subject, and finishes the process when the recovered error has occurred.

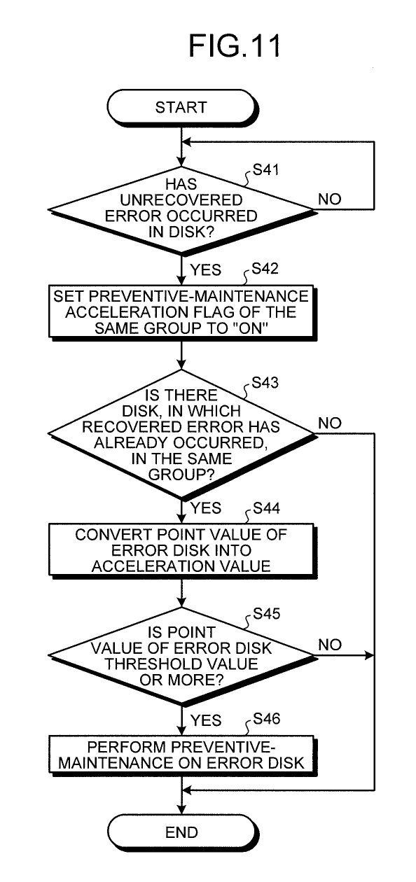

Next, a process procedure when an unrecovered error has occurred in a disk will be described with reference to FIG. 11. FIG. 11 is a flowchart illustrating a process procedure when an unrecovered error has occurred in a disk according to the second embodiment. Further, it is assumed that the defect detecting unit 103 has detected that an error occurred in a disk D.

First, the defect type determining unit 104 determines whether the defect detected by the defect detecting unit 103 is an unrecovered error (step S41). Then, in the case where the defect is not an unrecovered error (No in step S41), the process procedure proceeds to step S41.

Meanwhile, in the case where the defect is an unrecovered error (Yes in step S41), the unrecovered-error control unit 106 sets the preventive-maintenance acceleration flag of the lot group of the error disk D in the preventive-maintenance acceleration flag table 203 to “ON” (step S42). This is for accelerating the timing of preventive-maintenance on a disk D belonging to the same lot group as the disk D in which the unrecovered error has occurred.

Subsequently, the unrecovered-error control unit 106 determines whether there is a disk D in which a recovered error has already occurred in the same lot group as the error disk D (step S43). In the case where there is no disk in which a recovered error has already occurred (No in step S43), the unrecovered-error control unit 106 finishes the process when the unrecovered error has occurred.

Meanwhile, in the case where there is a disk in which a recovered error has already occurred (Yes in step S43), the unrecovered-error control unit 106 updates the point value of the recovered-error disk D in the defect occurrence history table 202 with an acceleration value into which the point value is converted (step S44).

Subsequently, the unrecovered-error control unit 106 determines whether the point value of the recovered-error disk D reaches or exceeds the threshold value (step S45). In the case where the point value of the recovered-error disk is less than the threshold value (No in step S45), the unrecovered-error control unit 106 determines that the disk D is not a preventive-maintenance subject, and finishes the process when the unrecovered error has occurred.

Meanwhile, in the case where the point value of the recovered-error disk D reaches or exceeds the threshold value (Yes in step S45), the unrecovered-error control unit 106 determines that it is the timing of preventive-maintenance and extracts the disk D as a preventive-maintenance subject. Next, the preventive-maintenance performing unit 107 performs preventive-maintenance on data stored in the recovered-error disk D extracted as the preventive-maintenance subject (step S46) and finishes the process when the unrecovered error has occurred.

### Effect of Second Embodiment

According to the second embodiment, when an unrecovered error occurs in a disk D in which recovered errors have occur a predetermined number of times, the recovered-error control unit 105 detects whether a recovered error has occurred in another disk D belonging to the same lot group as the disk D in which the unrecovered error has occurred. Then, when a recovered error in another disk D is detected, the recovered-error control unit 105 adds the acceleration value representing a value larger than the normal value to the point value of another disk D. Then, if the added point value reaches the threshold, the recovered-error control unit 105 extracts another disk D as a preventive-maintenance subject.

According to the related configuration, when a recovered error occurs in another disk D belonging to the same lot group as the disk D in which the unrecovered error has occurred, the recovered-error control unit 105 adds the acceleration value larger than the normal value to the point value of another disk D. Therefore, the recovered-error control unit 105 can accelerate the timing of extracting another disk D as a preventive-maintenance subject by making the timing for the point value of another disk D to reach the threshold value earlier than normal. As a result, the recovered-error control unit 105 can perform preventive-maintenance before an unrecovered error occurs in another disk D in which the recovered error has occurred and prevent loss of data of another disk D.

Further, according to the second embodiment, when a recovered error has occurred in another disk D before an unrecovered error occurs in the disk D in which the recovered error has occurred, the unrecovered-error control unit 106 converts the point value of another disk D into an acceleration value. Then, if the converted point value reaches the threshold value, the unrecovered-error control unit 106 extracts another disk D as a preventive-maintenance subject.

According to the related configuration, when a recovered error has occurred in another disk D before an unrecovered error occurs in the disk D in which the recovered error has occurred, the unrecovered-error control unit 106 converts the point value of another disk D into an acceleration value. Therefore, the unrecovered-error control unit 106 can accelerate the timing of extracting another disk D as a preventive-maintenance subject by making the timing when the point value of another disk D reaches the threshold value earlier than normal. As a result, the unrecovered-error control unit 106 can perform preventive-maintenance before an unrecovered error occurs in another disk D in which the recovered error has occurred and prevent loss of data of another disk D.

### Third Embodiment

In the RAID device 2 according to the second embodiment, with respect to another disk of the same lot group as the disk in which the unrecovered error occurs after recovered errors have occurred the predetermined number of times, the acceleration value larger than the normal value is added to the point value for each recovered error. Then, at the timing when the added point value reaches the threshold value, the RAID device 2 sets another disk as a preventive-maintenance subject. However, the RAID device 2 is not limited thereto, but may set another disk of the same lot group as the disk in which the unrecovered error has occurred after the recovered errors occurred a predetermined number of times, as a preventive-maintenance subject, at the timing when recovered errors have occurred in another disk the same number of times.

In a third embodiment, a case will be described where, with respect to a disk of the same lot group with another disk in which an unrecovered error has occurred after recovered errors have occurred a predetermined number of times, the RAID device 2 sets the disk as a preventive-maintenance subject at the timing when recovered errors have occurred in the disk the same number of times.

### Configuration of Raid Controller of Raid Device According to Third Embodiment

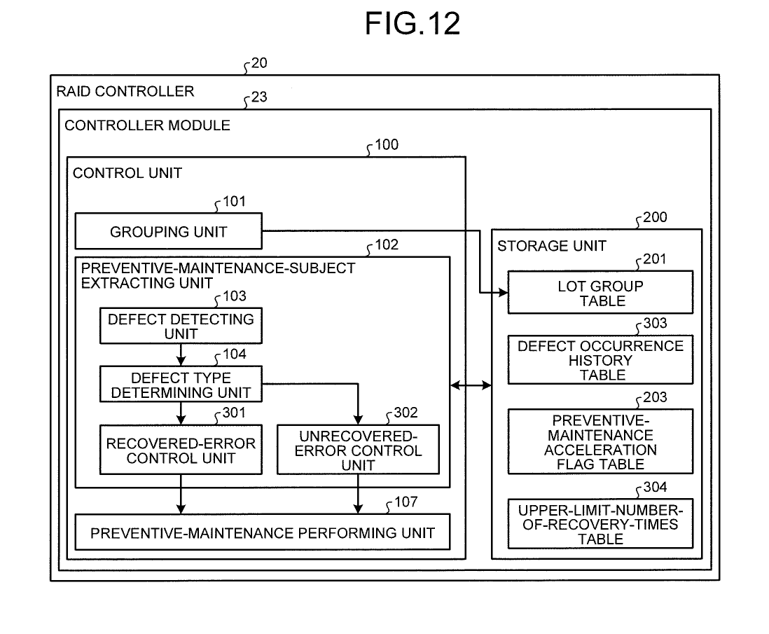

FIG. 12 is a functional block diagram illustrating a configuration of a RAID controller according to the third embodiment. Further, identical components with those of the RAID controller illustrated in FIG. 3 are denoted by the same reference symbols and a description of the same components and operations will not be repeated. The third embodiment differs from the second embodiment in that a recovered-error control unit 301 and an unrecovered-error control unit 302 are used instead of the recovered-error control unit 105 and the unrecovered-error control unit 106, respectively. Further, the third embodiment differs from the second embodiment in that a defect occurrence history table 303 is used instead of the defect occurrence history table 202. Furthermore, the third embodiment differs from the second embodiment in that an upper-limit-number-of-recovery-times table 304 is added to the storage unit 200. Moreover, the configuration of the RAID device according to the third embodiment is the same as the configuration of the RAID device according to the second embodiment and thus a description of the configuration will not be repeated.

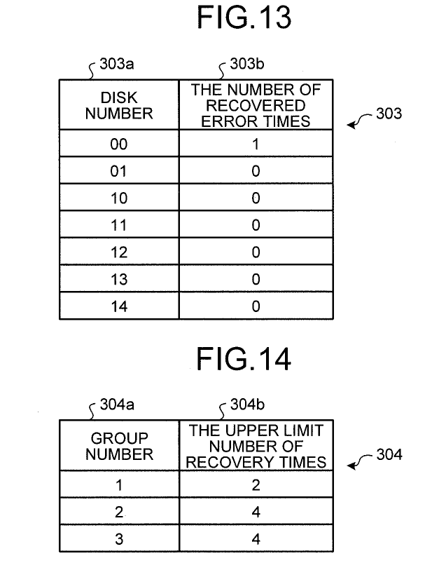

The defect occurrence history table 303 stores an occurrence history of recovered errors that occurred in a disk D. Here, the defect occurrence history table 303 will be described with reference to FIG. 13. FIG. 13 is a view illustrating an example of a data structure of the defect occurrence history table according to the third embodiment. As illustrated in FIG. 13, the defect occurrence history table 303 stores a number of recovered error times 303b to be mapped to each disk D with a disk number 303a. The number of recovered error times 303b represents the number of recovered errors that occurred in the disk D denoted by the disk number 303a. That is, the number of recovered error times 303b represents the occurrence history of recovered errors.

Returning to FIG. 12, the upper-limit-number-of-recovery-times table 304 stores the upper limit number of recovered error occurrence representing the timing of preventive-maintenance for each lot group. Here, the upper-limit-number-of-recovery-times table 304 will be described with reference to FIG. 14. FIG. 14 is a view illustrating an example of a data structure of the upper-limit-number-of-recovery-times table. As illustrated in FIG. 14, the upper-limit-number-of-recovery-times table 304 stores an upper limit number of recovery times 304b to be mapped to each lot group with the group number 304a. The upper limit number of recovery times 304b represents the upper limit number of recovered error times becoming the timing of preventive-maintenance on a disk D belonging to the lot group. In the case of accelerating the timing of preventive-maintenance, an acceleration value is set to the upper limit number of recovery times 304b, and in the case where the timing of preventive-maintenance is not accelerated, a normal value is set to the upper limit number of recovery times 304b. The normal value represents, for example, “4”. The acceleration value represents, for example, the number of times recovered errors have occurred before an unrecovered error occurs.

Returning to FIG. 12, in the case where the defect type determining unit 104 determines that a defect is a recovered error, the recovered-error control unit 301 performs a recovered error process. Specifically, the recovered-error control unit 301 adds “1” to the number of recovered error times representing the occurrence history of recovered errors with respect to the disk D in which the recovered error has occurred. Then, the recovered-error control unit 301 stores the added number of recovered error times in the defect occurrence history table 303 to be mapped to the disk D in which the recovered error has occurred.

Further, the recovered-error control unit 301 reads the upper limit number of recovery times 304b of the lot group including the disk D in which the recovered error has occurred from the upper-limit-number-of-recovery-times table 304. Next, the recovered-error control unit 301 determines whether the number of recovered error times of the disk D in which the recovered error has occurred reaches or exceeds the upper limit number of recovery times, on the basis of the defect occurrence history table 303. Then, in the case of determining that the number of recovered error times reaches or exceeds the upper limit number of recovery times, the recovered-error control unit 301 determines that it is the timing of preventive-maintenance and extracts the disk D in which the recovered error has occurred, as a preventive-maintenance subject. Meanwhile, in the case of determining that the number of recovered error times is less than the upper limit number of recovery times, the recovered-error control unit 301 determines that the disk D in which the recovered error has occurred is not a preventive-maintenance subject.

In the case where the defect type determining unit 104 determines that the defect is an unrecovered error, the unrecovered-error control unit 302 performs an unrecovered error process. Specifically, the unrecovered-error control unit 302 reads the number of recovered error times of the error disk D in which the unrecovered error has occurred, on the basis of the defect occurrence history table 303. Further, the unrecovered-error control unit 302 reads the lot group including the error disk D in which the unrecovered error has occurred, on the basis of the lot group table 201. Then, with respect to the lot group including the error disk D, the unrecovered-error control unit 302 stores the number of recovered error times of the disk D as an acceleration value in the upper limit number of recovery times 304b of the upper-limit-number-of-recovery-times table 304. This is for accelerating the timing of preventive-maintenance of another disk D belonging to the same lot group as the disk D in which the unrecovered error has occurred.

Further, the unrecovered-error control unit 302 determines whether there is a disk D, in which a recovered error has already occurred, in the same lot group as the error disk D, on the basis of the lot group table 201 and the defect occurrence history table 303. Then, in the case of determining that there is a disk D in which a recovered error has already occurred, the unrecovered-error control unit 106 determines whether the number of recovered error times reaches or exceeds the upper limit number of recovery times. Next, in the case of determining that the number of recovered error times reaches or exceeds the upper limit number of recovery times, the unrecovered-error control unit 302 determines that it is the timing of preventive-maintenance and extracts the disk D in which the recovered error has occurred as a preventive-maintenance subject. Meanwhile, in the case of determining that the number of recovered error times is less than the upper limit number of recovery times, the unrecovered-error control unit 302 determines that the disk D in which the recovered error has occurred is not a preventive-maintenance subject.

### Example of Preventive-Maintenance Acceleration Process According to Third Embodiment

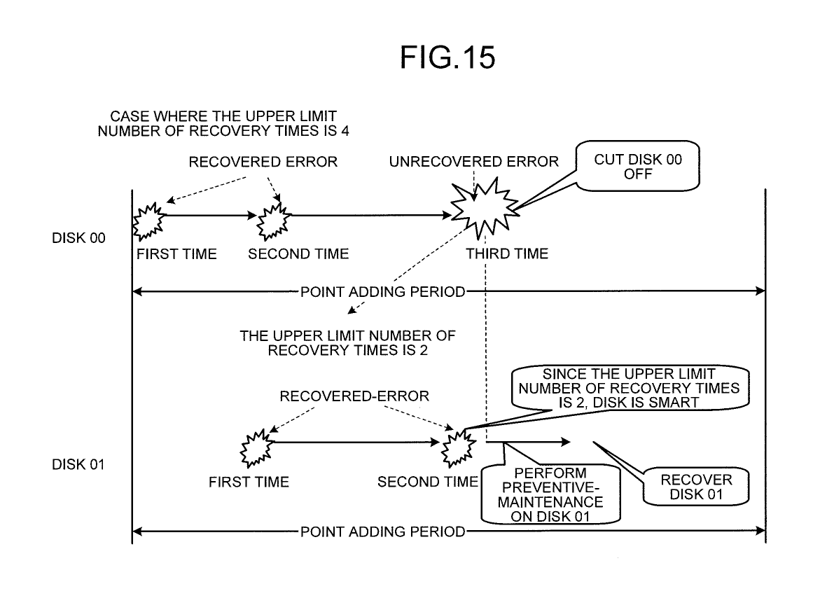

Next, an example of a preventive-maintenance acceleration process will be described with reference to FIG. 15. FIG. 15 is a view illustrating an example of a preventive-maintenance acceleration process according to the third embodiment. As illustrated in FIG. 15, a horizontal axis represents a time axis and a vertical axis represents disk numbers. Further, it is assumed that a disk 00 and a disk 01 illustrated in FIG. 15 belong to the same lot group. Furthermore, it is assumed that the normal value is 4 and the initial upper limit number of recovery times is the normal value.

First, with respect to the disk having disk number 00, a first recovered error occurs, and a second recovered error occurs as time passes. Meanwhile, after the first recovered error has occurred in the disk 00, with respect to the disk whose disk number is 01, a first recovered error occurs, and a second recovered error occurs as time passes. Whenever a recovered error occurs in a disk, the recovered-error control unit 301 adds “1” to the number of recovered error times representing a recovered-error occurrence history with respect to the disk D in which the recovered error has occurred.

Next, with respect to the disk 00, an unrecovered error occurs the third time before the number of recovered error times reaches or exceeds the upper limit number of recovery times (which is the normal value of 4), and the unrecovered-error control unit 302 cuts the disk 00 off. At this time, the unrecovered-error control unit 302 sets 2 which is the number of recovered error times of the disk 00, as an acceleration value, in the upper limit number of recovery times of the lot group including the disk 00. Then, the unrecovered-error control unit 302 determines whether the number of recovered error times of the disk 01 has already reached or exceeded the upper limit number of recovery times. Since the number of recovered error times (which is 2) reaches or exceeds the upper limit number of recovery times (which is the acceleration value of 2), the unrecovered-error control unit 302 performs preventive-maintenance on the disk 01 before the number of recovered error times becomes the normal value (which is 4). As a result, the disk 01 can prevent an unrecovered error.

### Changes in the Numbers of Recovered Error Times of Defect Occurrence History Table According to Third Embodiment

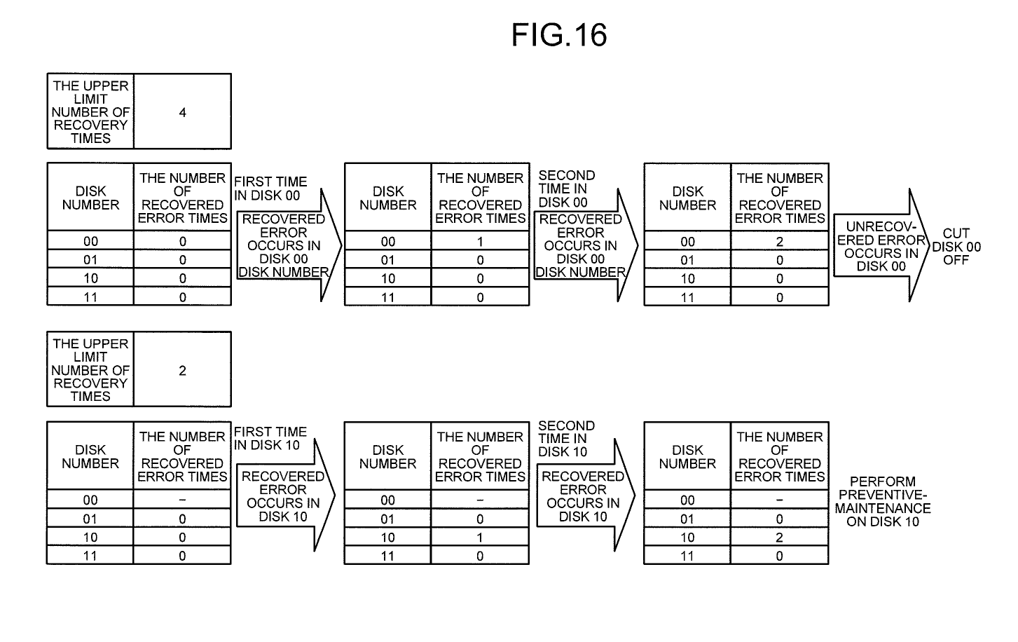

Next, changes in the numbers of recovered error times of the defect occurrence history table will be described with reference to FIG. 16. FIG. 16 is a view illustrating changes in the numbers of recovered error times in the defect occurrence history table according to the third embodiment. Further, it is assumed that the disk 00 and a disk 10 illustrated in FIG. 16 belong to the same lot group. Furthermore, it is assumed that the normal value is 4, and the initial upper limit number of recovery times is the normal value.

As illustrated in FIG. 16, whenever a recovered error occurs in a disk, a value is added to the number of recovered error times 303b of the disk, in which the recovered error has occurred, in the defect occurrence history table 303. First, with respect to the disk 00, if a first recovered error occurs, the recovered-error control unit 301 adds “1” to the number of recovered error times 303b of the defect occurrence history table 303, such that the number of recovered error times is 1. Next, with respect to the disk 00, if a second recovered error occurs, the recovered-error control unit 301 adds “1” to the number of recovered error times 303b of the defect occurrence history table 303, such that the number of recovered error times is 2.

Next, with respect to the disk 00, if an unrecovered error occurs, the unrecovered-error control unit 302 cuts the disk 00 off. Then, the unrecovered-error control unit 302 sets 2, which is the number of recovered error times of the disk 00, as an acceleration value, in the upper limit number of recovery times of the upper-limit-number-of-recovery-times table 304 corresponding to the number of the group including the disk 00. That is, the unrecovered-error control unit 302 determines that there is a possibility that an unrecovered error will occur even in the disk 10 in the same lot group as the disk 00 in which the unrecovered error has occurred by a factor based on the lot, and accelerates the timing of preventive-maintenance.

Then, with respect to the disk 10 in the same lot group as the disk 00, if a recovered error occurs, the recovered-error control unit 301 adds “1” to the number of recovered error times 303b of the defect occurrence history table 303, such that the number of recovered error times is 1. Next, with respect to the disk 10, if a second recovered error occurs, the recovered-error control unit 301 adds “1” to the number of recovered error times 303b of the defect occurrence history table 303, such that the number of recovered error times is 2.

Then, the recovered-error control unit 301 determines whether the number of recovered error times of the disk 10 in which the recovered error has occurred reaches or exceeds the upper limit number of recovery times. Here, since the number of recovered error times 303b of the disk 10 is 2 and the upper limit number of recovery times is 2 representing the acceleration value, the recovered-error control unit 301 determines that the number of recovered error times reaches or exceeds the upper limit number of recovery times. That is, the recovered-error control unit 301 determines that it is the timing of preventive-maintenance on the disk 10 and extracts the disk 10 as a preventive-maintenance subject. Next, the preventive-maintenance performing unit 107 performs preventive-maintenance on the disk 10 extracted as the preventive-maintenance subject.

Further, there is a case where a recovered error has already occurred in the disk in the same lot group as the disk 00 when an unrecovered error occurs in the disk 00. In this case, the unrecovered-error control unit 302 determines whether the number of recovered error times of the disk reaches or exceeds the upper limit number of recovery times (acceleration value), and sets the disk as a preventive-maintenance subject in the case where the number of recovered error times reaches or exceeds the upper limit number of recovery times.

### Process Procedure of Preventive-Maintenance Acceleration Process According to Third Embodiment

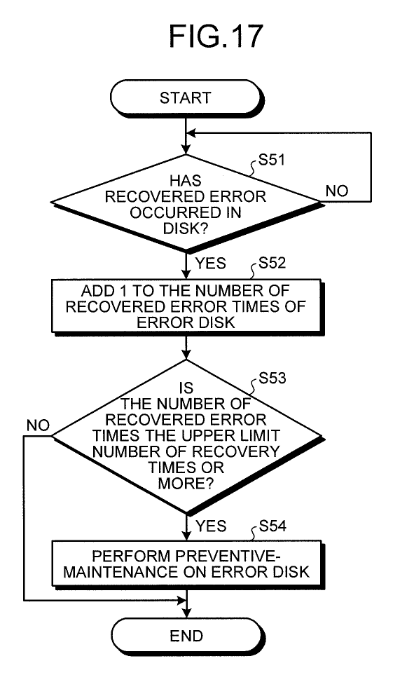

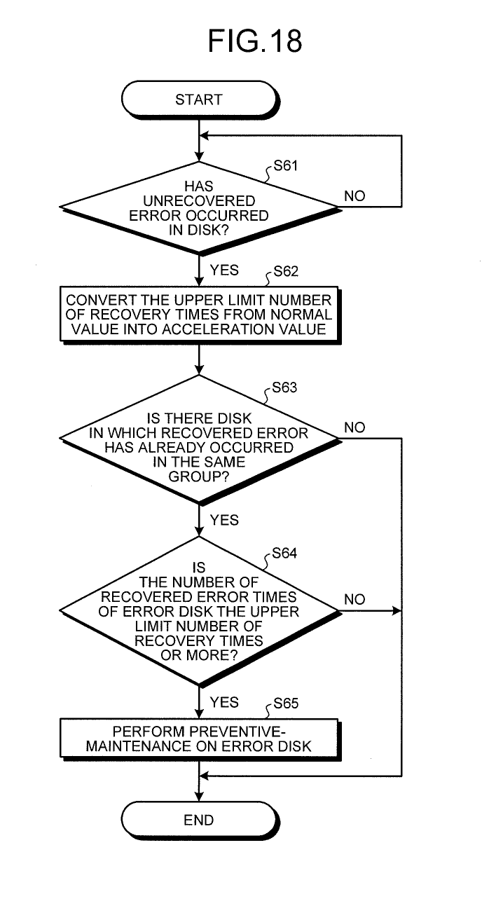

Next, a predetermined procedure of a predetermine-maintenance acceleration process according to the third embodiment will be described with reference to FIGS. 17 and 18. First, a process procedure when a recovered error has occurred in a disk will be described with reference to FIG. 17. FIG. 17 is a flowchart illustrating a process procedure when a recovered error has occurred in a disk according to the third embodiment. Further, identical processes of the process procedure of preventive-maintenance acceleration process according to the third process with those of the process procedure of preventive-maintenance acceleration process (FIG. 10) are denoted by the same symbols and a description of the same processes will not be repeated. Furthermore, it is assumed that the defect detecting unit 103 has detected that an error occurred in a disk D.

First, the defect type determining unit 104 determines whether the defect detected by the defect detecting unit 103 is a recovered error (step S51). Then, in the case where the defect is not a recovered error (No in step S51), the process procedure proceeds to step S31.

Meanwhile, in the case where the defect is a recovered error (Yes in step S51), the recovered-error control unit 301 adds “1” to the number of recovered error times of the error disk D, in which the recovered error has occurred, in the defect occurrence history table 303 (step S52). Subsequently, the recovered-error control unit 301 determines whether the number of recovered error times of the error disk D in which the recovered error has occurred reaches or exceeds the upper limit number of recovery times of the lot group including the disk D (step S53).

In the case where the number of recovered error times reaches or exceeds the upper limit number of recovery times (Yes in step S53), the recovered-error control unit 301 determines that it is the timing of preventive-maintenance and extracts the error disk D in which the recovered error has occurred as a preventive-maintenance subject. Next, the preventive-maintenance performing unit 107 performs preventive-maintenance on the data stored in the error disk D extracted as the preventive-maintenance subject (step S54) and finishes the processes when the recovered error has occurred.

Meanwhile, in the case where the number of recovered error times is less than the upper limit number of recovery times (No in step S53), the recovered-error control unit 301 determines that the error disk D is not a preventive-maintenance subject and finishes the processes when the recovered error has occurred.

Next, a process procedure when an unrecovered error has occurred in a disk will be described with reference to FIG. 18. FIG. 18 is a flowchart illustrating a process procedure when an unrecovered error has occurred in a disk according to the third embodiment. Further, identical processes of the process procedure of preventive-maintenance acceleration process according to the third process with those of the process procedure of preventive-maintenance acceleration process according to the second embodiment (FIG. 11) are denoted by the same symbols and a description of the same processes will not be repeated. Furthermore, it is assumed that the defect detecting unit 103 has detected that an error occurred in a disk D.

First, the defect type determining unit 104 determines whether the defect detected by the defect detecting unit 103 is an unrecovered error (step S61). Then, in the case where the defect is not an unrecovered error (No in step S61), the process procedure proceeds to step S61.

Meanwhile, in the case where the defect is an unrecovered error (Yes in step S61), with respect to the lot group of the error disk D in which the unrecovered error has occurred, the unrecovered-error control unit 302 converts the upper limit number of recovery times from the normal value into the acceleration value (step S62). This is for accelerating the timing of preventive-maintenance on another disk D belonging to the same lot group as the error disk D in which the unrecovered error has occurred. Specifically, the unrecovered-error control unit 302 reads the lot group including the error disk D, in which the unrecovered error has occurred, from the lot group table 201. Then, the unrecovered-error control unit 302 reads the number of recovered error times of the error disk D from the defect occurrence history table 303. Next, with respect to the lot group of the error disk D, the unrecovered-error control unit 302 stores the number of recovered error times of the error disk D as the acceleration value in the upper limit number of recovery times 304b of the upper-limit-number-of-recovery-times table 304.

Subsequently, the unrecovered-error control unit 302 determines whether there is a disk D, in which a recovered error has already occurred, in the same lot group as the error disk D (step S63). In the case where there is no disk D in which a recovered error has already occurred (No in step S63), the unrecovered-error control unit 302 finishes the process when the unrecovered error has occurred.

Meanwhile, in the case where there is a disk D in which a recovered error has already occurred (Yes in step S63), the unrecovered-error control unit 302 determines whether the number of recovered error times reaches or exceeds the upper limit number of recovery times, by using the defect occurrence history table 303 (step S64). In the case where the number of recovered error times of the recovered-error disk D is less than the upper limit number of recovery times (No in step S64), the unrecovered-error control unit 106 determines that the disk D is not a preventive-maintenance subject and finishes the process when the unrecovered error has occurred.

Meanwhile, in the case where the number of recovered error times of the recovered-error disk D reaches or exceeds the upper limit number of recovery times (Yes in step S64), the unrecovered-error control unit 302 determines that it is the timing of preventive-maintenance and extracts the disk D as a preventive-maintenance subject. Then, the preventive-maintenance performing unit 107 performs preventive-maintenance on data stored in the recovered-error disk D extracted as the preventive-maintenance subject (step S65), and finishes the process when the unrecovered error has occurred.

### Effect of Third Embodiment

According to the third embodiment, the recovered-error control unit 301 measures the number of recovered errors that occurred until the unrecovered error occurs in the disk D in which recovered error occurred, and the unrecovered-error control unit 302 stores the number of recovered errors that occurred as the upper limit number of recovery times. Then, if the number of recovered error occurrences of another disk D in the same lot group as the disk D in which the unrecovered error has occurred reaches the measured upper limit number of recovery times, the unrecovered-error control unit 302 extracts another disk D as a preventive-maintenance subject.

According to the related configuration, the number of recovered errors that occurred until the unrecovered error occurs in the disk in which the recovered errors occurred is measured, and the measured number of recovered error occurrences is stored as the upper limit number of recovery times. Therefore, the recovered-error control unit 301 can accelerate the timing of extracting another disk D belonging to the same lot group as the disk D in which the unrecovered error has occurred as the preventive-maintenance subject. As a result, the recovered-error control unit 301 can perform preventive-maintenance on another disk D in which the recovered error has occurred before an unrecovered error occurs and prevent loss of data of another disk D.

### Fourth Embodiment

In the RAID device 2 according to the second embodiment, there has been described the case of accelerating the timing of preventive-maintenance on the disk in the same lot group as the disk in which the unrecovered error that occurred after recovered errors have occurred the predetermined number of times, without considering the redundancy of the RAID. However, the RAID device 2 is not limited thereto, but may accelerate the timing of preventive-maintenance on the disk in the same lot group as the disk, in which the unrecovered error has occurred after recovered errors have occurred the predetermined number of times, in consideration of the redundancy of the RAID.

In a fourth embodiment, there will be described a case where the RAID device 2 accelerates the timing of preventive-maintenance on the disk in the same lot group as the disk, in which the unrecovered error has occurred after recovered errors occurred the predetermined number of times, in consideration of the redundancy of the RAID.

### Configuration of Raid Controller of Raid Device According to Fourth Embodiment

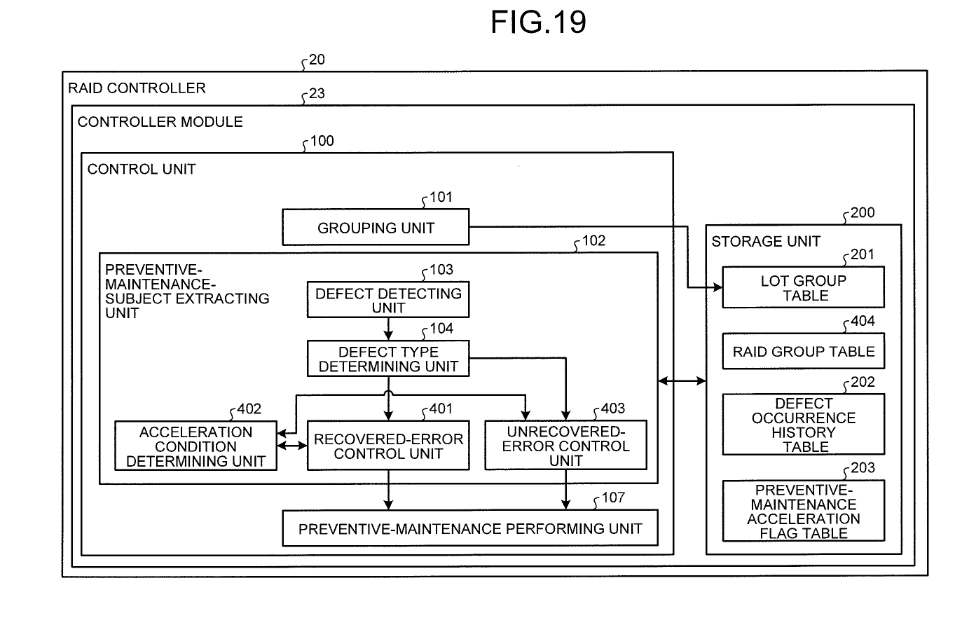

FIG. 19 is a functional block diagram illustrating a configuration of a RAID controller according to the fourth embodiment. Further, identical components with those of the RAID controller illustrated in FIG. 3 are denoted by the same reference symbols and a description of the same components and operations will not be repeated. The fourth embodiment differs from the second embodiment in that an acceleration condition determining unit 402 is added to the preventive-maintenance-subject extracting unit 102. Further, the fourth embodiment differs from the second embodiment in that a recovered-error control unit 401 and an unrecovered-error control unit 403 are used instead of the recovered-error control unit 105 and the unrecovered-error control unit 106 of the preventive-maintenance-subject extracting unit 102, respectively. Furthermore, the fourth embodiment differs from the second embodiment in that a RAID group table 404 is added to the storage unit 200. Moreover, the configuration of the RAID device according to the fourth embodiment is the same as the configuration of the RAID device according to the second embodiment and thus a description of the configuration will not be repeated.

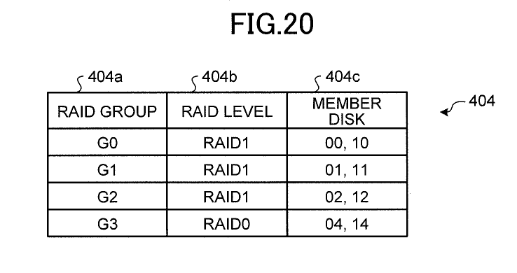

The RAID group table 404 stores a RAID group including a plurality of disks D. Here, the RAID group table 404 will be described with reference to FIG. 20. FIG. 20 is a view illustrating an example of a data structure of the RAID group table according to the fourth embodiment. As illustrated in FIG. 20, the RAID group table 404 stores a RAID level 404b and a member disk 404c to be mapped to each RAID group 404a. The RAID group 404a is a number identifying a RAID group in the RAID controller 20. The RAID level 404b is the RAID level of the RAID group. The member disk 404c is a number of each disk D belonging to the RAID group.

Returning to FIG. 19, in the case where the defect type determining unit 104 determines that a defect is a recovered error, the recovered-error control unit 401 performs a recovered error process. Specifically, the recovered-error control unit 401 reads the lot group including the error disk D in which the recovered error has occurred, on the basis of the lot group table 201. Further, in the case where a preventive-maintenance acceleration flag of the read lot group is not “ON”, the recovered-error control unit 401 adds a normal value to a point value representing a recovered-error occurrence history with respect to the error disk D. Furthermore, in the case where the preventive-maintenance acceleration flag of the read lot group is “ON”, the recovered-error control unit 401 asks the acceleration condition determining unit 402, which will be described below, to determine whether the error disk satisfies an acceleration condition.

Then, if obtaining a determination result representing that the error disk D satisfies the acceleration condition from the acceleration condition determining unit 402, the recovered-error control unit 401 adds an acceleration value to the point value representing the recovered error occurrence history with respect to the error disk D. Meanwhile, if obtaining a determination result representing that the error disk D does not satisfy the acceleration condition from the acceleration condition determining unit 402, the recovered-error control unit 401 adds a normal value to the point value representing the recovered error occurrence history with respect to the error disk D. Next, the recovered-error control unit 401 stores the added point value in the defect occurrence history table 202 to be mapped to the error disk D in which the recovered error has occurred. Further, the preventive-maintenance acceleration flag is stored in the preventive-maintenance acceleration flag table 203 and is set by the unrecovered-error control unit 403 to be described below.

Moreover, the recovered-error control unit 401 determines whether the point value of the error disk D reaches or exceeds the threshold value. Then, in the case where the point value reaches or exceeds the threshold value, the recovered-error control unit 401 determines that it is the timing of preventive-maintenance and extracts the error disk D in which the recovered error has occurred as a preventive-maintenance subject. Meanwhile, in the case where the point value is less than the threshold value, the recovered-error control unit 401 determines that the error disk D in which the recovered error has occurred is not a preventive-maintenance subject.

The acceleration condition determining unit 402 determines the acceleration condition of the error disk D in which the recovered error has occurred. Specifically, if being asked to determine whether the error disk D satisfies the acceleration condition by the recovered-error control unit 401, the acceleration condition determining unit 402 reads data regarding the RAID group of the error disk D from the RAID group table 404. That is, the acceleration condition determining unit 402 reads the RAID level and the member disk of the error disk D from the RAID group table 404. Further, the acceleration condition determining unit 402 reads the point value representing the recovered error occurrence history of the read member disk from the defect occurrence history table 202. Then, the acceleration condition determining unit 402 determines whether the acceleration condition is satisfied, on the basis of the RAID level of the error disk D and the point value representing the recovered error occurrence history of the member disk.

For example, in the case where the RAID level of the error disk D is RAID0, since there is no redundancy, the acceleration condition determining unit 402 determines that the acceleration condition is satisfied regardless of the point value of the member disk. This is because loss of data cannot be prevented if an unrecovered error occurs in the error disk D.

For example, in the case where the RAID level of the error disk D is RAID1, when the point value of each member disk except for the error disk D is 0, the acceleration condition determining unit 402 determines that the acceleration condition is not satisfied. This is because a recovered error has not occurred in the member disk except for the error disk D and there is redundancy so as to prevent loss of data even if an unrecovered error occurs in the error disk D. Meanwhile, in the case where the RAID level of the error disk D is RAID1, when the point value of any one of the member disks except for the error disk D exceeds 0, the acceleration condition determining unit 402 determines that the acceleration condition is satisfied. This is because, in the case where a recovered error has occurred in any one of the member disks except for the error disk D, loss of data cannot be prevented if an unrecovered error occurs in the error disk D in which the recovered error has occurred and the member disks. Further, this is the same even when the RAID level is RAID5.

For example, in the case where the RAID level of the error disk D is RAID6, when the point value of only one of the member disks exceeds 0, the acceleration condition determining unit 402 determines that the acceleration condition is not satisfied. This is because, even when an unrecovered error occurs in the error disk D in which the recovered error has occurred and the member disks, since there is redundancy, data can be recovered by the remaining disk of the member disks. Meanwhile, in the case where the RAID level of the error disk D is the RAID6, when the point values of two or more of the member disks exceed 0, the acceleration condition determining unit 402 determines that the acceleration condition is satisfied. This is because there is no redundancy already and thus data cannot be recovered by the remaining disk of the member disks if an unrecovered error occurs in the error disk D in which the recovered error has occurred and the member disks.

In the case where the defect type determining unit 104 determines that the defect is an unrecovered error, the unrecovered-error control unit 403 performs an unrecovered error process. Specifically, the unrecovered-error control unit 403 reads the lot group including the error disk D in which the unrecovered error has occurred, on the basis of the lot group table 201. Further, the unrecovered-error control unit 403 stores a value representing “ON” in the preventive-maintenance acceleration flag of the preventive-maintenance acceleration flag table 203 with respect to the lot group, to accelerate the timing of preventive-maintenance on the disk D belonging to the read lot group.

Furthermore, the unrecovered-error control unit 403 determines whether there is a disk D, in which a recovered error has already occurred, in the same lot group as the error disk D, by using the lot group table 201 and the defect occurrence history table 202. Then, in the case where there is a disk D in which a recovered error has already occurred, the unrecovered-error control unit 403 asks the acceleration condition determining unit 402 to determine whether the disk D satisfies the acceleration condition.

Then, if obtaining a determination result representing that the disk D satisfies the acceleration condition from the acceleration condition determining unit 402, the unrecovered-error control unit 403 updates the point value of the disk D already set in the defect occurrence history table 202 with an acceleration value into which the point value is converted. Next, the unrecovered-error control unit 403 determines whether the point value of the disk D updated with the acceleration value reaches or exceeds the threshold value. Then, in the case where the point value reaches or exceeds the threshold value, the unrecovered-error control unit 403 determines that it is the timing of preventive-maintenance and extracts the disk D in which the recovered error has already occurred, as a preventive-maintenance subject. Meanwhile, in the case of determining that the point value is less than the threshold, the unrecovered-error control unit 403 determines that the disk D is not a preventive-maintenance subject.

### Specific Example of Acceleration Condition Determination According to Fourth Embodiment

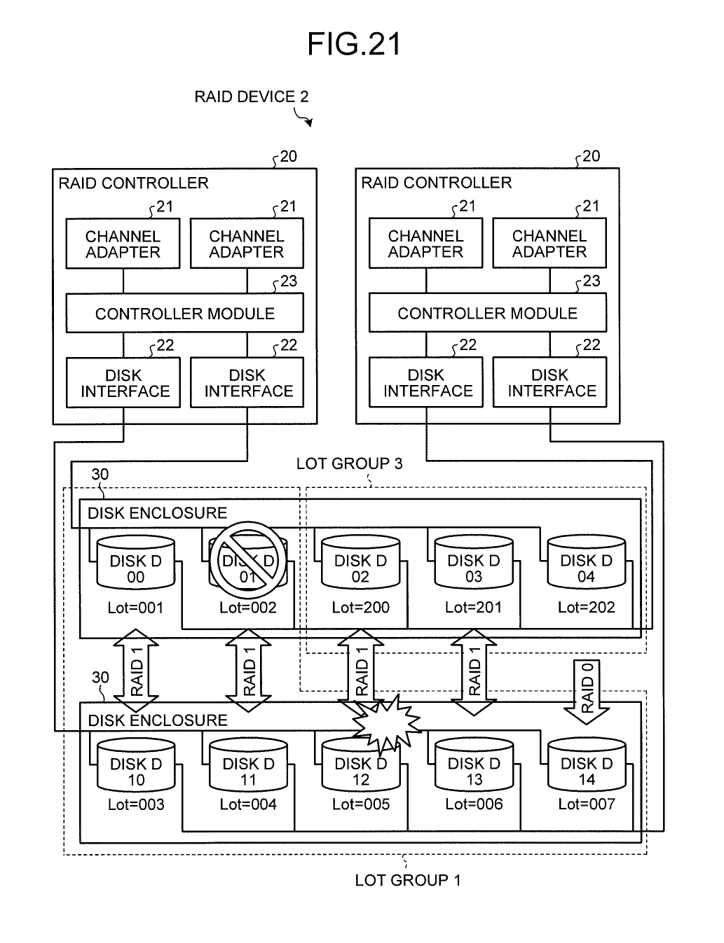

Next, FIG. 21 is a view illustrating a specific example of acceleration condition determination according to the fourth embodiment. As illustrated in FIG. 21, disks D00 to D01 and D10 to D14 with the lot numbers 1 to 99 belong to lot group 1, and disks D02 to D04 with lot numbers 200 to 299 belong to lot group 3. Further, each pair of the disk D00 and the disk D10, the disk D01 and the disk D11, the disk D02 and the disk D12, and the disk D03 and the disk D13 form the RAID1. Further, the disk D04 and the disk D14 form the RAID0. Furthermore, it is assumed that the disk D01 belonging to the lot group 1 has already been malfunctioned. Moreover, it is assumed that an unrecovered error has occurred after recovered error occurred a predetermined number of times in the disk D12 belonging to the lot group 1.

For example, it is assumed that a recovered error occurs in the disk D00 belonging to the lot group 1. Then, if being asked to determine whether the disk D00 satisfies the acceleration condition by the recovered-error control unit 401, the acceleration condition determining unit 402 determines whether the disk D00 satisfies the acceleration condition. Here, since the RAID level of the disk D00 is the RAID1 and any recovered error has not occurred in the disk D10 of the member disk, the acceleration condition determining unit 402 determines that there is redundancy and determines that the disk D00 does not satisfy the acceleration condition.

For example, it is assumed that a recovered error occurs in the disk D10 belonging in the lot group 1. Then, if being asked to determine whether the disk D10 satisfies the acceleration condition by the recovered-error control unit 401, the acceleration condition determining unit 402 determines whether the disk D10 satisfies the acceleration condition. Here, since the RAID level of the disk D10 is the RAID1 and any recovered error has not occurred in the disk D00 which is the member disk, the acceleration condition determining unit 402 determines that there is redundancy and determines that the disk D10 does not satisfy the acceleration condition.

For example, it is assumed that a recovered error has already occurred in the disk D00 belonging to the lot group 1 and a recovered error occurs in the disk D10. Then, if being asked to determine whether the disk D10 satisfies the acceleration condition by the recovered-error control unit 401, the acceleration condition determining unit 402 determines whether the disk D10 satisfies the acceleration condition. Here, since the RAID level of the disk D10 is the RAID1 but the recovered error has already occurred in the disk D00 which is the member disk, the acceleration condition determining unit 402 determines that the disk D10 satisfies the acceleration condition. That is, since data loss will occur if an unrecovered error occurs in the disk D00 and the disk D10, in order to perform preventive-maintenance before an unrecovered error occurs in the disk D10, the acceleration condition determining unit 402 determines that the disk D10 satisfies the acceleration condition.

For example, it is assumed that a recovered error occurs in the disk D11 belonging to the lot group 1. Then, if being asked to determine whether the disk D11 satisfies the acceleration condition by the recovered-error control unit 401, the acceleration condition determining unit 402 determines whether the disk D11 satisfies the acceleration condition. Here, since the RAID level of the disk D101 is the RAID1 but the disk D01 which is the member disk has already been malfunctioned, the acceleration condition determining unit 402 determines that the disk D11 satisfies the acceleration condition. That is, since data loss will occur if an unrecovered error occurs in the disk D11, in order to perform preventive-maintenance before an unrecovered error occurs in the disk D11, the acceleration condition determining unit 402 determines that the disk D11 satisfies the acceleration condition.

For example, it is assumed that a recovered error occurs in the disk D13 belonging to the lot group 1. Then, if being asked to determine whether the disk D13 satisfies the acceleration condition by the recovered-error control unit 401, the acceleration condition determining unit 402 determines whether the disk D13 satisfies the acceleration condition. Here, the acceleration condition determining unit 402 determines that the RAID level of the disk D13 is the RAID1 and there is redundancy, and determines that the disk D13 does not satisfy the acceleration condition.

For example, it is assumed that a recovered error occurs in the disk D14 belonging to the lot group 1. Then, if being asked to determine whether the disk D14 satisfies the acceleration condition by the recovered-error control unit 401, the acceleration condition determining unit 402 determines whether the disk D14 satisfies the acceleration condition. Here, the acceleration condition determining unit 402 determines that the RAID level of the disk D14 is the RAID1 and there is no redundancy, and determines that the disk D14 satisfies the acceleration condition.

### Process Procedure of Preventive-Maintenance Acceleration Process According to Fourth Embodiment

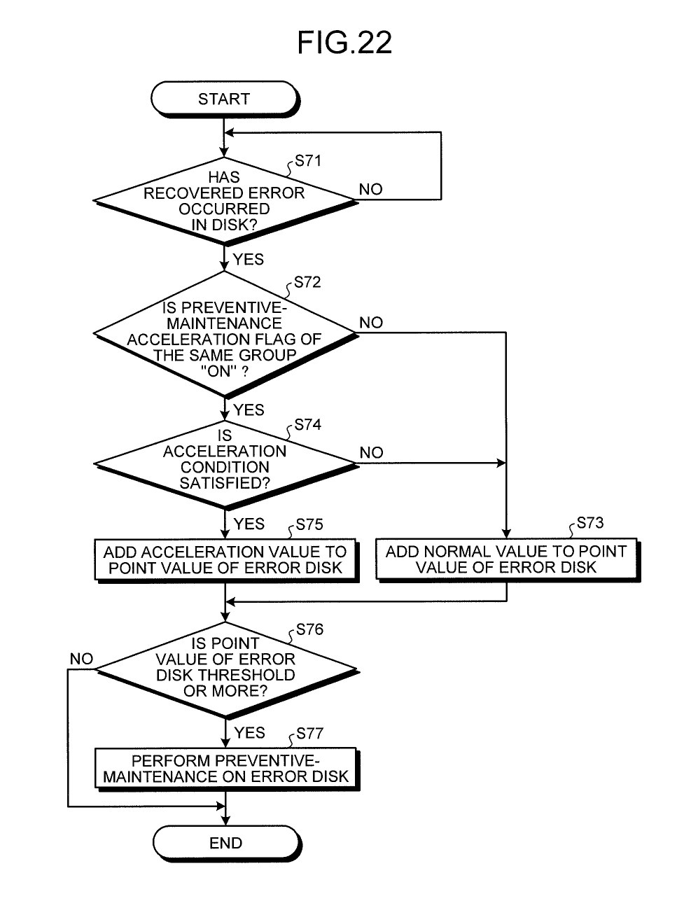

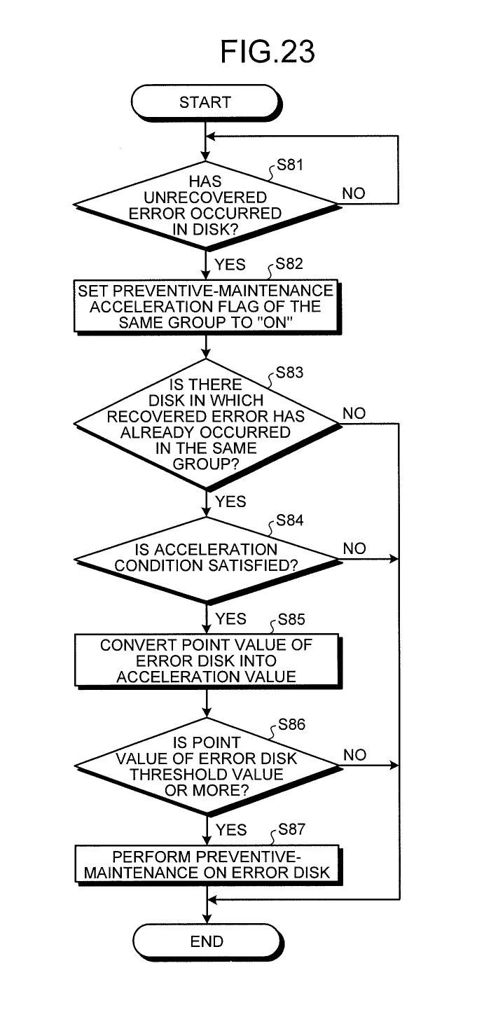

Next, a predetermined procedure of a predetermine-maintenance acceleration process according to the fourth embodiment will be described with reference to FIGS. 22 and 23. First, a process procedure when a recovered error has occurred in a disk will be described with reference to FIG. 22. FIG. 22 is a flowchart illustrating a process procedure when a recovered error has occurred in a disk according to the fourth embodiment. Further, identical processes of the process procedure of preventive-maintenance acceleration process according to the fourth process with those of the process procedure of preventive-maintenance acceleration process (FIG. 10) are denoted by the same symbols and a description of the same processes will not be repeated. Furthermore, it is assumed that the defect detecting unit 103 has detected that an error occurred in a disk D.

First, the defect type determining unit 104 determines whether the defect detected by the defect detecting unit 103 is a recovered error (step S71). Then, in the case where the defect is not a recovered error (No in step S71), the process procedure proceeds to step S71.

Meanwhile, when the defect is a recovered error (Yes in step S71), the recovered-error control unit 401 determines whether the preventive-maintenance acceleration flag of the lot group including the disk D in which the recovered error has occurred is “ON” (step S72).

Subsequently, when the preventive-maintenance acceleration flag of the lot group including the error disk D is not “ON” (No in step S72), the recovered-error control unit 401 adds the normal value to the point value of the error disk D (step S73). Meanwhile, when the preventive-maintenance acceleration flag of the lot group including the error disk D is “ON” (Yes in step S72), the recovered-error control unit 401 asks the acceleration condition determining unit 402 to determine whether the error disk D satisfies the acceleration condition.

Then, if being asked to determine whether the error disk D satisfies the acceleration condition by the recovered-error control unit 401, the acceleration condition determining unit 402 determines the acceleration condition of the error disk D (step S74). Specifically, the acceleration condition determining unit 402 reads the RAID level and the member disk of the error disk D from the RAID group table 404. Then, the acceleration condition determining unit 402 reads the point value representing the recovered error occurrence history of the read member disk from the defect occurrence history table 202. Next, the acceleration condition determining unit 402 determines whether the error disk D satisfies the acceleration condition, on the basis of the RAID level of the error disk D and the point value of the member disk.

Then, in the case where the acceleration condition determining unit 402 determines that the error disk D satisfies the acceleration condition (Yes in step S74), the recovered-error control unit 401 adds the acceleration value representing a value larger than the normal value to the point value of the error disk D (step S75). Meanwhile, in the case where the acceleration condition determining unit 402 determines that the error disk D does not satisfy the acceleration condition (No in step S74), the recovered-error control unit 401 adds the normal value to the point value of the error disk D (step S73).

Subsequently, the recovered-error control unit 401 determines whether the point value of the error disk D reaches or exceeds the threshold value (step S76). Then, in the case where the point value of the error disk D reaches or exceeds the threshold value (Yes in step S76), the recovered-error control unit 401 determines that it is the timing of preventive-maintenance and extracts the error disk D as a preventive-maintenance subject. Next, the preventive-maintenance performing unit 107 performs preventive-maintenance on data stored in the disk D extracted as the preventive-maintenance subject (step S77), and finishes the process when the recovered error has occurred.

Meanwhile, in the case where the point value of the error disk D is less than the threshold value (No in step S76), the recovered-error control unit 401 determines that the error disk D is not a preventive-maintenance subject and finishes the process when the recovered error has occurred.

Next, a process procedure when an unrecovered error has occurred in a disk will be described with reference to FIG. 23. FIG. 23 is a flowchart illustrating a process procedure when an unrecovered error has occurred in a disk according to the fourth embodiment. Further, it is assumed that the defect detecting unit 103 has detected that an error occurred in a disk D.

First, the defect type determining unit 104 determines whether the defect detected by the defect detecting unit 103 is an unrecovered error (step S81). Then, in the case where the defect is not an unrecovered error (No in step S81), the process procedure proceeds to step S41.

Meanwhile, in the case where the defect is an unrecovered error (Yes in step S81), with respect to the lot group of the error disk D, the unrecovered-error control unit 403 sets the preventive-maintenance acceleration flag of the preventive-maintenance acceleration flag table 203 to “ON” (step S82). This is for accelerating the timing of preventive-maintenance on another disk D belonging to the same lot group as the disk D in which the unrecovered error has occurred.

Subsequently, the unrecovered-error control unit 403 determines whether there is a disk D, in which a recovered error has already occurred, in the same lot group as the error disk D (step S83). In the case where there is no disk D in which a recovered error has already occurred (No in step S83), the unrecovered-error control unit 403 finishes the process when the unrecovered error has occurred.

Meanwhile, in the case where there is a disk D in which a recovered error has already occurred (Yes in step S83), the unrecovered-error control unit 403 asks the acceleration condition determining unit 402 to determine whether the disk D in which the recovered error has already occurred satisfies the acceleration condition.

Then, if being asked to determine whether the recovered-error disk D satisfies the acceleration condition by the unrecovered-error control unit 403, the acceleration condition determining unit 402 determines the acceleration condition of the disk D (step S84). Specifically, the acceleration condition determining unit 402 reads the RAID level and the member disk of the recovered-error disk D from the RAID group table 404. Then, the acceleration condition determining unit 402 reads the point value representing the recovered error occurrence history of the read member disk from the defect occurrence history table 202. Next, the acceleration condition determining unit 402 determines whether the recovered-error disk D satisfies the acceleration condition, on the basis of the RAID level of the error disk D and the point value of the member disk.

Then, in the case of determining that the recovered-error disk D does not satisfy the acceleration condition (No in step S84), the unrecovered-error control unit 403 finishes the process when the unrecovered error has occurred. Meanwhile, in the case of determining that the recovered-error disk D satisfies the acceleration condition (Yes in step S84), the unrecovered-error control unit 403 updates the point value of the disk D in the defect occurrence history table 202 with an acceleration value into which the point value is converted (step S85).

Subsequently, the unrecovered-error control unit 403 determines whether the point value of the recovered-error disk D reaches or exceeds the threshold value (step S86). When the point value of the recovered-error disk is less than the threshold value (No in step S86), the unrecovered-error control unit 106 determines that the disk D is not a preventive-maintenance subject, and finishes the process when the unrecovered error has occurred.

Meanwhile, in the case where the point value of the recovered-error disk D reaches or exceeds the threshold value (Yes in step S86), the unrecovered-error control unit 403 determines that it is the timing of preventive-maintenance and extracts the disk D as a preventive-maintenance subject. Then, the preventive-maintenance performing unit 107 performs preventive-maintenance on data stored in the recovered-error disk D extracted as the preventive-maintenance subject (step S87) and finishes the process when the unrecovered error has occurred.

### Effect of Fourth Embodiment

According to the fourth embodiment, the RAID group table 404 stores a RAID group including a plurality of disks D. Further, the recovered-error control unit 401 detects occurrence of a recovered error in another disk D belonging to the same lot group as the disk D in which the unrecovered error has occurred after the recovered error occurred. Then, the recovered-error control unit 401 extracts another disk D in which the recovered error has occurred as a preventive-maintenance subject, on the basis of the RAID level of the RAID group and the point value representing the recovered error occurrence history of the member disk of another disk D.

According to the related configuration, another disk D belonging to the same lot group as the disk D in which the unrecovered error has occurred is extracted as the preventive-maintenance subject on the basis of the RAID level and the recovered error occurrence history of the member disk. Therefore, the recovered-error control unit 401 can consider the redundancy of data from the RAID level and the recovered error occurrence history of the member disk with respect to another disk D, and thus can reliably prevent loss of the data of another disk D. Further, the recovered-error control unit 401 does not accelerate preventive-maintenance on all of recovered-error disks D belonging to the same lot group with the disk D in which the unrecovered error has occurred, but accelerates preventive-maintenance on another urgent disk D. Therefore, the recovered-error control unit 401 can effectively perform preventive-maintenance on another disk D even when there are a small number of hot spare disks.

Further, in the recovered-error control unit 401 according to the fourth embodiment, on the basis of a result of determination on whether another disk D satisfies the acceleration condition by the acceleration condition determining unit 402, the predetermined value (the normal value or the acceleration value) is added to the point value of another disk D. Then, if the point value reaches the threshold value, the recovered-error control unit 401 sets another disk D as the preventive-maintenance subject. However, the recovered-error control unit 401 is not limited thereto. The recovered-error control unit 401 may set the predetermined value (the normal value or the acceleration value) as the upper limit number of recovery times, on the basis of the result of determination on whether another disk D satisfies the acceleration condition, by the acceleration condition determining unit 402. Then, if the number of recovered error occurrences of another disk D reaches the upper limit number of recovery times, the recovered-error control unit 401 may set another disk D as the preventive-maintenance subject. In this case, the normal value may be, for example, 4, and the acceleration value may be, for example, the number of recovered error occurrences of the disk D in which the unrecovered error has occurred.

### Fifth Embodiment

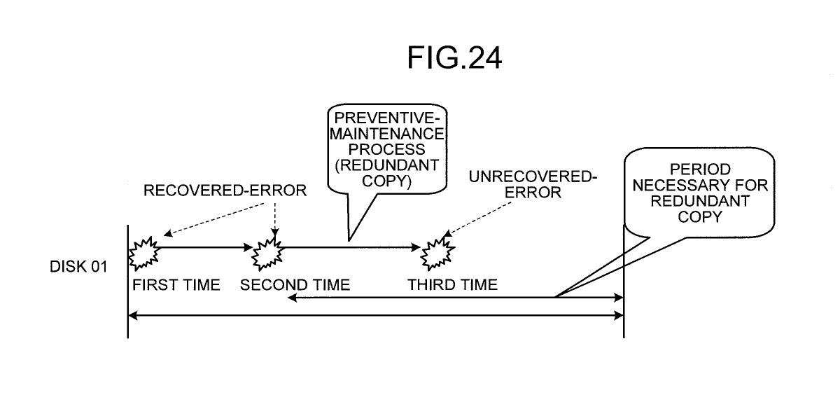

In the RAID device 2 according to the second embodiment, there was described the case of accelerating the preventive-maintenance by using the acceleration value larger than the normal value as an added value added with respect to another disk in the same lot group as the disk in which the unrecovered error has occurred after the recovered errors. However, a case where an unrecovered error occurs in the disk during preventive-maintenance on the disk for which the preventive-maintenance timing has accelerated may also be expected. Here, a case where an unrecovered error occurs during preventive-maintenance will be described with reference to FIG. 24.

FIG. 24 is a view illustrating a case where an unrecovered error occurs during preventive-maintenance. As illustrated in FIG. 24, with respect to a disk 01 in the same lot group with another disk (not illustrated) in which an unrecovered error has occurred after a recovered error occurred, the timing of preventive-maintenance is accelerated. That is, with respect to the disk 01, a preventive-maintenance process (redundant copy) is performed when a second recovered error occurs. However, with respect to the disk 01, in the case where a period from when the second recovered error has occurred to when an unrecovered error occurs is short, the unrecovered error may occur during redundant copy of the disk 01. That is, with respect to the disk 01, in the case where the period from when the second recovered error has occurred to when the unrecovered error occurs is shorter than a period necessary for the redundant copy, even when the timing of preventive-maintenance is accelerated, the redundant copy may be too late. In the fifth embodiment, an object is to complete a redundant copy until the unrecovered error occurs even when the period from when the second recovered error has occurred to when the unrecovered error occurs is short.

In the fifth embodiment, there will be described a case of accelerating the timing of preventive-maintenance in consideration of a period necessary for a preventive-maintenance process with respect to a disk in the same lot group with another disk in which an unrecovered error has occurred after recovered errors have occurred the predetermined number of times. Further, the recovered error of the embodiment means a defect which results from a predetermined factor based on a lot and is recoverable through retries. Furthermore, the unrecovered error means a defect which becomes a factor of immediate cutoff based on a lot and is non-recoverable.

### Configuration of Raid Controller of Raid Device According to Fifth Embodiment

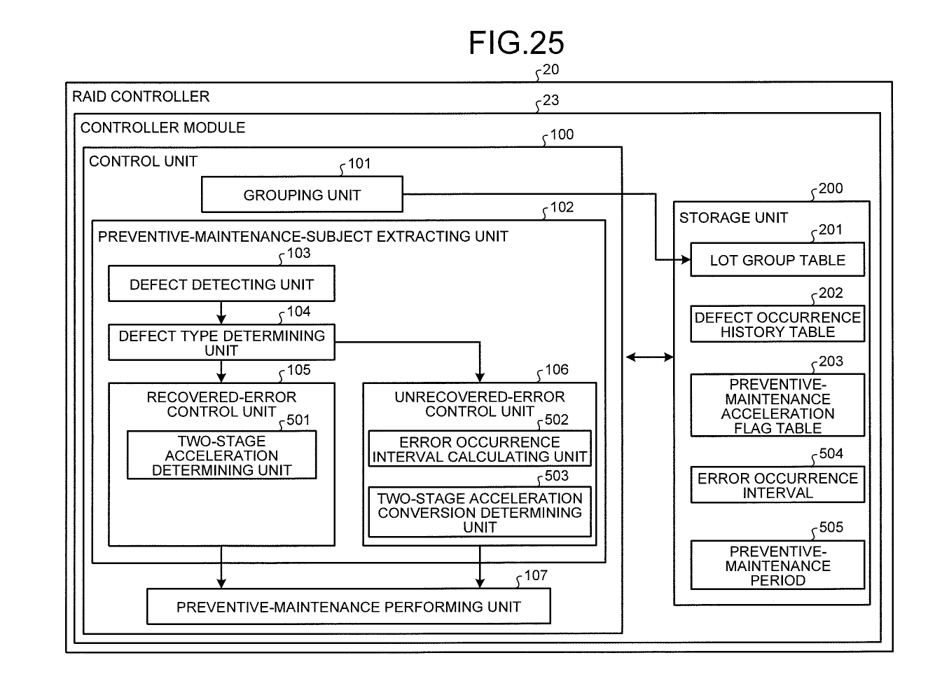

FIG. 25 is a functional block diagram illustrating a configuration of a RAID controller according to the fifth embodiment. Further, identical components with those of the RAID controller illustrated in FIG. 3 are denoted by the same reference symbols and a description of the same components and operations will not be repeated. The fifth embodiment differs from the second embodiment in that a two-stage acceleration determining unit 501 is added to the recovered-error control unit 105, and an error occurrence interval calculating unit 502 and a two-stage acceleration conversion determining unit 503 are added to the unrecovered-error control unit 106. Further, the fifth embodiment differs from the second embodiment in that an error occurrence interval 504 and a preventive-maintenance period 505 are added to the storage unit 200. Furthermore, the configuration of the RAID device according to the fifth embodiment is the same as the configuration of the RAID device according to the second embodiment and thus a description of the configuration will not be repeated.

The error occurrence interval 504 stores a period (hereinafter, referred to as “an error occurrence interval”) from a recovered error right before the unrecovered error of the disk in which the unrecovered error has occurred after the recovered errors occurred to the unrecovered error. The preventive-maintenance period 505 stores a period (hereinafter, referred to as “a preventive-maintenance period”) necessary for a preventive-maintenance process (redundant copy) in advance. The preventive-maintenance period 505 may be a preventive-maintenance period of each disk and may be an average period of preventive-maintenance periods of all disks.

In the case where the defect type determining unit 104 determines that a defect is a recovered error, the recovered-error control unit 105 performs a recovered error process. Specifically, the recovered-error control unit 105 reads the lot group including the error disk D in which the recovered error has occurred, on the basis of the lot group table 201. Next, in the case where a preventive-maintenance acceleration flag of the read lot group is not “ON”, the recovered-error control unit 105 adds a normal value to a point value representing a recovered-error occurrence history with respect to the error disk D. Meanwhile, in the case where the preventive-maintenance acceleration flag of the read lot group is “ON”, the recovered-error control unit 105 adds an acceleration value larger than the normal value to the point value representing the recovered-error occurrence history with respect to the error disk D for performing acceleration. Moreover, the recovered-error control unit 105 performs a two-stage acceleration determining process by the two-stage acceleration determining unit 501 to be described below.

The two-stage acceleration determining unit 501 determines whether to perform two-stage acceleration on the error disk D in which the recovered error has occurred, on the basis of the error occurrence interval 504 and the preventive-maintenance period 505. Specifically, the two-stage acceleration determining unit 501 reads the error occurrence interval 504 and the preventive-maintenance period 505 from the storage unit 200. Then, in the case where the error occurrence interval 504 is shorter than the preventive-maintenance period 505, the two-stage acceleration determining unit 501 determines that there is a high possibility that an unrecovered error will occur during preventive-maintenance, and performs two-stage acceleration. For example, the two-stage acceleration determining unit 501 sets, for example, twice the acceleration value larger than the normal value, as a two-stage acceleration value, and adds the two-stage acceleration value to the point value representing the recovered error occurrence history with respect to the error disk D.

In the case where the defect type determining unit 104 determines that the defect is an unrecovered error, the unrecovered-error control unit 106 performs an unrecovered-error process. Specifically, the unrecovered-error control unit 106 reads the lot group including the error disk D in which the recovered error has occurred, on the basis of the lot group table 201. Then, in order to accelerate the timing of preventive-maintenance on a disk D belonging to the read lot group, the unrecovered-error control unit 106 stores a value representing “ON” in the preventive-maintenance acceleration flag of the preventive-maintenance acceleration flag table 203 with respect to the corresponding lot group.

Moreover, the unrecovered-error control unit 106 determines whether there is a disk D, in which a recovered error has already occurred, in the same lot group as the error disk D, by using the lot group table 201 and the defect occurrence history table 202. Then, in the case of determining that there is a disk D in which a recovered error has already occurred, with the respect to the disk D, the unrecovered-error control unit 106 updates the point value already set in the defect occurrence history table 202 with an acceleration value into which the point value is converted.

Next, the unrecovered-error control unit 106 determines whether the point value of the disk D in which the recovered error has already occurred reaches or exceeds the threshold value. In the case of determining that the point value reaches or exceeds the threshold value, the unrecovered-error control unit 106 determines that it is the timing of preventive-maintenance, and extracts the disk in which the recovered error has already occurred, as the preventive-maintenance subject. Meanwhile, in the case of determining that the point value is less than the threshold value, the unrecovered-error control unit 106 performs a two-stage acceleration conversion determining process by the two-stage acceleration conversion determining unit 503 to be described below.

The error occurrence interval calculating unit 502 calculates the error occurrence interval of the error disk D in which the unrecovered error has occurred. Specifically, with respect to the error disk D in which the unrecovered error has occurred, the error occurrence interval calculating unit 502 measures an interval from the recovered error right before the unrecovered error to the unrecovered error. Next, the error occurrence interval calculating unit 502 stores the measured interval in the error occurrence interval 504.

The two-stage acceleration conversion determining unit 503 determines whether to perform the two-stage acceleration on the error disk D in which the recovered error has already occurred, on the basis of the error occurrence interval and the preventive-maintenance period. Specifically, the two-stage acceleration conversion determining unit 503 reads the error occurrence interval 504 and the preventive-maintenance period 505 from the storage unit 200. Further, in the case where the error occurrence interval 504 is shorter than the preventive-maintenance period 505, the two-stage acceleration conversion determining unit 503 determines that there is a high possibility that an unrecovered error will occur during preventive-maintenance, and updates the point value representing the recovered error occurrence history of the error disk D with a two-stage acceleration value into which the point value is converted. For example, the two-stage acceleration conversion determining unit 503 sets twice the acceleration value larger than the normal value as the two-stage acceleration value, and updates the point value already set in the defect occurrence history table 202 with the two-stage acceleration value into which the point value is converted.

### Process Procedure of Preventive-Maintenance Acceleration Process According to Fifth Embodiment

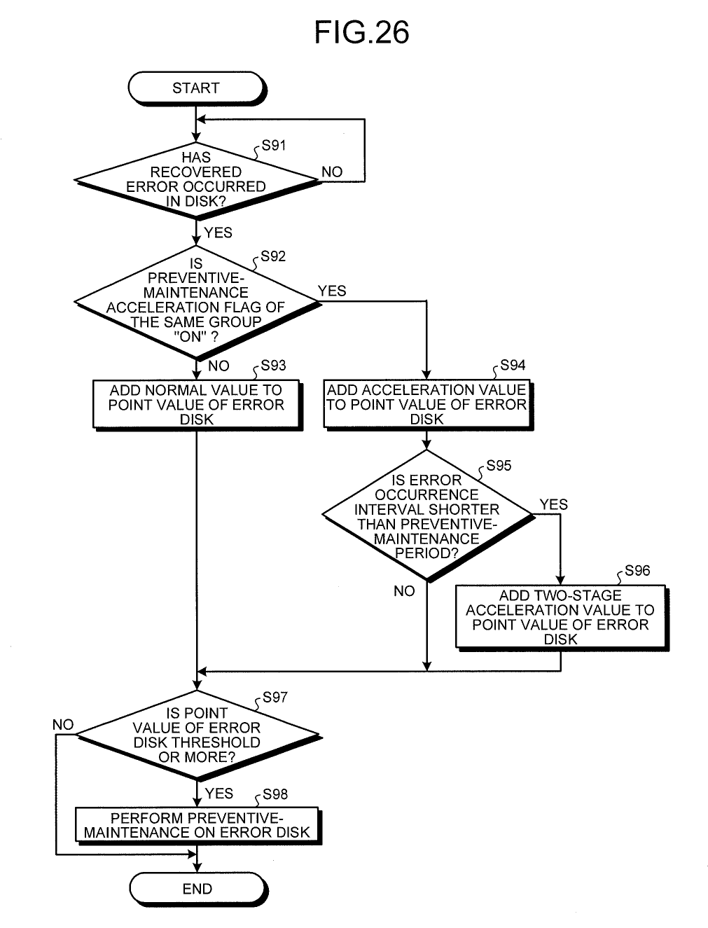

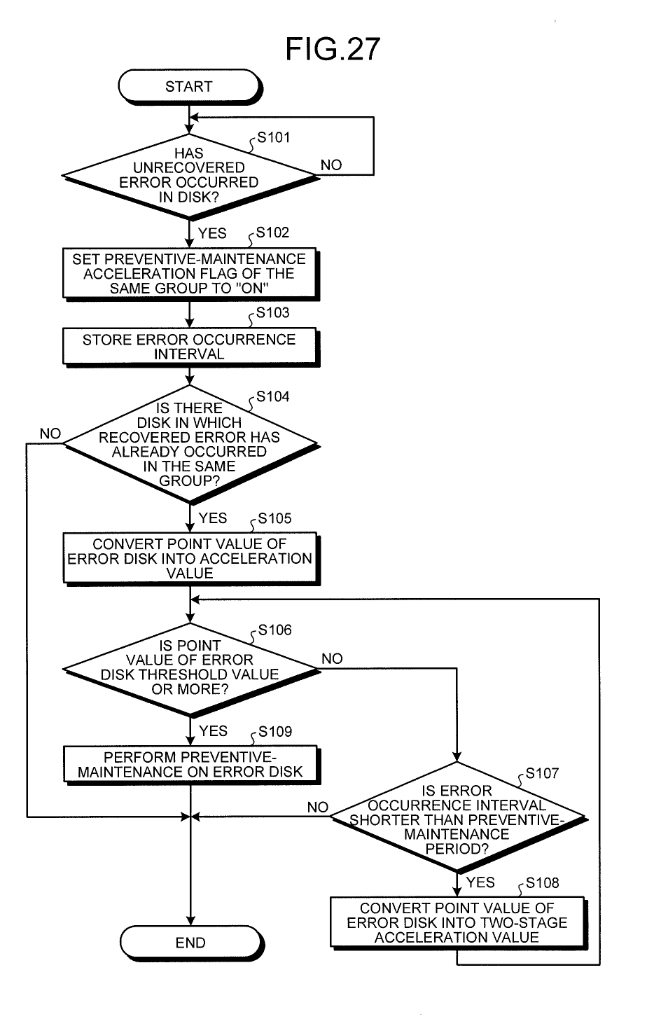

Next, a predetermined procedure of a predetermine-maintenance acceleration process according to the fifth embodiment will be described with reference to FIGS. 26 and 27. First, a process procedure when a recovered error has occurred in a disk will be described with reference to FIG. 26. FIG. 26 is a flowchart illustrating a process procedure when a recovered error has occurred in a disk according to the fifth embodiment. Further, identical processes of the process procedure of preventive-maintenance acceleration process according to the fifth process with those of the process procedure of preventive-maintenance acceleration process (FIG. 10) are denoted by the same symbols and a description of the same processes will not be repeated. Furthermore, it is assumed that the defect detecting unit 103 has detected that an error occurred in a disk D.

First, the defect type determining unit 104 determines whether the defect detected by the defect detecting unit 103 is a recovered error (step S91). Then, in the case where the defect is not a recovered error (No in step S91), the process procedure proceeds to step S91.

Meanwhile, in the case where the defect is a recovered error (Yes in step S91), the recovered-error control unit 105 determines whether the preventive-maintenance acceleration flag of the lot group including the disk D in which the recovered error has occurred is “ON” (step S92). Subsequently, in the case where the preventive-maintenance acceleration flag of the lot group including the error disk D is not “ON” (No in step S92), the recovered-error control unit 105 adds the normal value to the point value of the error disk D (step S93).

Meanwhile, in the case where the preventive-maintenance acceleration flag of the lot group including the error disk D is “ON” (Yes in step S92), the recovered-error control unit 105 adds the acceleration value to the point value of the error disk D for performing normal acceleration (step S94). Next, the two-stage acceleration determining unit 501 determines whether the error occurrence interval is shorter than the preventive-maintenance period (step S95). Specifically, the two-stage acceleration determining unit 501 reads the error occurrence interval 504 and the preventive-maintenance period 505 from the storage unit 200, and determines whether the error occurrence interval is shorter than the preventive-maintenance period.

Then, in the case where it is determined that the error occurrence interval is shorter than the preventive-maintenance period (Yes in step S95), the two-stage acceleration determining unit 501 adds the two-stage acceleration value to the point value of the error disk D (step S96), and proceeds to step S97. That is, the two-stage acceleration determining unit 501 determines that there is a high possibility that an unrecovered error will occur in the error disk D during preventive-maintenance, and adds the two-stage acceleration value to the point value of the defect occurrence history table 202 with respect to the error disk D. The two-stage acceleration value is set to, for example, twice the acceleration value larger than the normal value.

Subsequently, the recovered-error control unit 105 determines whether the point value of the error disk D reaches or exceeds the threshold value (step S97). Then, in the case where the point value of the error disk D reaches or exceeds the threshold value (Yes in step S97), the recovered-error control unit 105 determines that it is the timing of preventive-maintenance, and extracts the error disk D as a preventive-maintenance subject. Next, the preventive-maintenance performing unit 107 performs preventive-maintenance on the data stored in the disk D extracted as the preventive-maintenance subject (step S98), and finishes the process when the recovered error has occurred.

Meanwhile, in the case where the point value of the error disk D is less than the threshold value (No in step S97), the recovered-error control unit 105 determines that the error disk D is not a preventive-maintenance subject, and finishes the process when the recovered error has occurred.

Next, a process procedure when an unrecovered error has occurred in a disk will be described with reference to FIG. 27. FIG. 27 is a flowchart illustrating a process procedure when an unrecovered error has occurred in a disk according to the fifth embodiment. Further, identical processes of the process procedure of preventive-maintenance acceleration process according to the fifth process with those of the process procedure of preventive-maintenance acceleration process according to the second embodiment (FIG. 11) are denoted by the same symbols and a description of the same processes will not be repeated. Furthermore, it is assumed that the defect detecting unit 103 has detected that an error occurred in a disk D.

First, the defect type determining unit 104 determines whether the defect detected by the defect detecting unit 103 is an unrecovered error (step S101). Then, in the case where the defect is not an unrecovered error (No in step S101), the process procedure proceeds to step S101.

Meanwhile, in the case where the defect is an unrecovered error (Yes in step S101), with respect to the lot group of the error disk D, the unrecovered-error control unit 106 sets the preventive-maintenance acceleration flag of the preventive-maintenance acceleration flag table 203 to “ON” (step S102). This is for accelerating the timing of preventive-maintenance on another disk D belonging to the same lot group as the disk D in which the unrecovered error has occurred.

Next, the error occurrence interval calculating unit 502 calculates the error occurrence interval of the error disk D in which the unrecovered error has occurred (step S103). Specifically, with respect to the error disk D in which the unrecovered error has occurred, the error occurrence interval calculating unit 502 measures the period from the recovered error right before the unrecovered error to the unrecovered error, and stores the measured period in the error occurrence interval 504.

Subsequently, the unrecovered-error control unit 106 determines there is a disk D, in which a recovered error has already occurred, in the same lot group as the error disk D (step S104). In the case where there is no disk in which a recovered error has already occurred (No in step S104), the unrecovered-error control unit 106 finishes the process when the unrecovered error has occurred.

Meanwhile, in the case where there is a disk in which a recovered error has already occurred (Yes in step S104), with respect to the recovered-error disk D, the unrecovered-error control unit 106 updates the point value of the defect occurrence history table 202 with an acceleration value into which the point value is converted (step S105).

Subsequently, the unrecovered-error control unit 106 determines whether the point value of the recovered-error disk D reaches or exceeds the threshold value (step S106). In the case where the point value of the recovered-error disk is less than the threshold value (No in step S106), the two-stage acceleration conversion determining unit 503 determines whether the error occurrence interval is shorter than the preventive-maintenance period (step S107). Specifically, the two-stage acceleration conversion determining unit 503 reads the error occurrence interval 504 and the preventive-maintenance period 505 from the storage unit 200, and determines whether the error occurrence interval is shorter than the preventive-maintenance period.

Then, in the case where the error occurrence interval is shorter than the preventive-maintenance period (Yes in step S107), the two-stage acceleration conversion determining unit 503 updates the point value of the recovered-error disk D in the defect occurrence history table 202 with a two-stage acceleration value into which the point value is converted (step S108). Then, the two-stage acceleration conversion determining unit 503 proceeds to step S106. That is, the two-stage acceleration conversion determining unit 503 determines that there is a high possibility that an unrecovered error will occur in the recovered-error disk D during preventive-maintenance, and converts the point value of the disk D in the defect occurrence history table 202 into the two-stage acceleration value. The two-stage acceleration value is set to, for example, twice the acceleration value larger than the normal value.

Meanwhile, in the case where it is determined that the error occurrence interval reaches or exceeds the preventive-maintenance period (No in steps S107), the two-stage acceleration conversion determining unit 503 determines that the point value of the recovered-error disk D is not a conversion subject, and finishes the process when the unrecovered error has occurred.

Meanwhile, in the case where the point value of the recovered-error disk D reaches or exceeds the threshold value (Yes in step S106), the unrecovered-error control unit 106 determines that it is the timing of preventive-maintenance and extracts the disk D as a preventive-maintenance subject. Next, the preventive-maintenance performing unit 107 performs preventive-maintenance on data stored in the recovered-error disk D extracted as the preventive-maintenance subject (step S109) and finishes the process when the unrecovered error has occurred.

### Example of Preventive-Maintenance Acceleration Process According to Fifth Embodiment

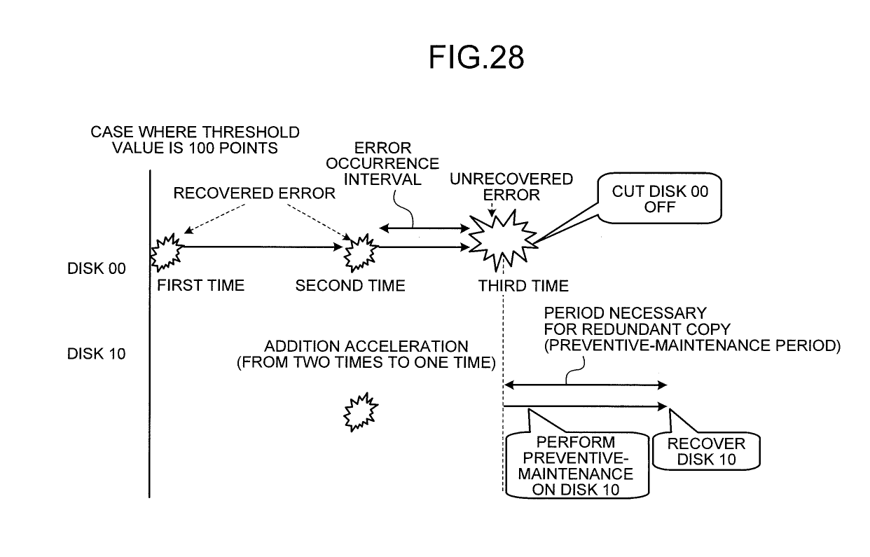

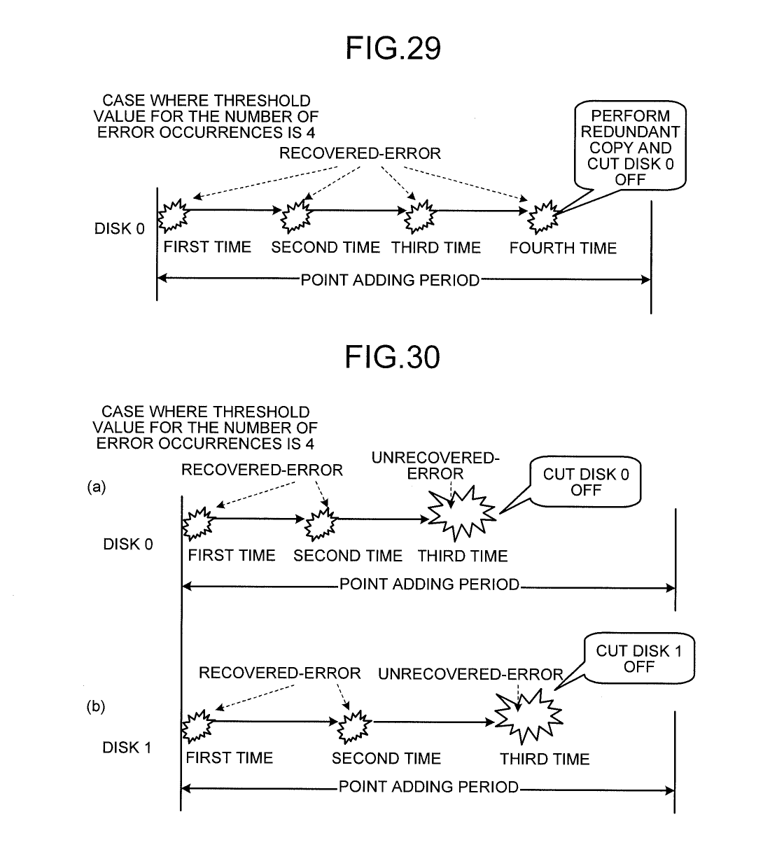

Next, an example of a preventive-maintenance acceleration process will be described with reference to FIG. 28. FIG. 28 is a view illustrating an example of a preventive-maintenance acceleration process according to the fifth embodiment. Further, it is assumed that the disk 00 and the disk 10 illustrated in FIG. 28 belong to the same lot group. Furthermore, it is assumed that the normal value is 26 points, the acceleration value is 52 points, the two-stage acceleration value is 104 points, and the threshold value is 100 points.

First, as illustrated in FIG. 28, a horizontal axis represents a time axis, and a vertical axis represents disk numbers. With respect to the disk whose disk number is 00, a first recovered error occurs, and a second recovered error occurs as time passes. Meanwhile, after the second recovered error occurs in the disk 00, with respect to the disk whose disk number is 10, a first recovered error occurs. Whenever a recovered error occurs in a disk, the recovered-error control unit 105 adds the normal value (26 points) to the point value representing the recovered-error occurrence history with respect to the disk D in which the recovered error has occurred.

Next, an unrecovered error occurs at the third time with respect to the disk 00 before the point value reaches or exceeds the threshold value, and the unrecovered-error control unit 106 cuts the disk 00 off. At this time, with respect to the disk 00, the error occurrence interval calculating unit 502 measures the period from the recovered error right before the unrecovered error to the unrecovered error, and stores the measured period in the error occurrence interval 504.

Next, since the disk 10 in which the first recovered error has already occurred is in the same lot group as the disk 00, the unrecovered-error control unit 106 determines that there is a possibility that an unrecovered error will occur due to a factor based on the lot. Then, the unrecovered-error control unit 106 converts the point value (26 points) already obtained by adding the normal value whenever a recovered error has occurred into the acceleration value (52 points).

Next, the unrecovered-error control unit 106 determines whether the converted point value of the disk 10 reaches or exceeds the threshold value. Then, since the unrecovered-error control unit 106 determines that the converted point value (52 points) of the disk 00 is less than the threshold value (100 points), the two-stage acceleration conversion determining unit 503 determines whether the error occurrence interval 504 is shorter than the preventive-maintenance period 505 already stored in the storage unit 200. Here, the two-stage acceleration conversion determining unit 503 determines that the error occurrence interval 504 is shorter than the preventive-maintenance period 505, and converts the point value (52 points) of the disk 10 into the two-stage acceleration value (104 points). That is, the two-stage acceleration conversion determining unit 503 determines that there is a high possibility that an unrecovered error will occur in the disk 10 during preventive-maintenance, and performs two-stage acceleration of the point value.

Next, the unrecovered-error control unit 106 determines whether the converted point value of the disk 10 reaches or exceeds the threshold value. Then, since the converted point value (102 points) of the disk 10 reaches or exceeds the threshold value (100 points), the unrecovered-error control unit 106 performs preventive-maintenance earlier than normal. As a result, it is possible to prevent an unrecovered error during preventive-maintenance.

### Effect of Fifth Embodiment

According to the fifth embodiment, the error occurrence interval calculating unit 502 calculates the error occurrence interval from the occurrence of the recovered error right before the unrecovered error to the occurrence of the unrecovered error. Next, the two-stage acceleration determining unit 501 determines whether the calculated error occurrence interval is shorter than the preventive-maintenance period necessary for preventive-maintenance on another disk D in which the recovered error has occurred. Then, in the case where it is determined that the error occurrence interval is shorter than the preventive-maintenance period, the recovered-error control unit 105 adds the two-stage acceleration value as a substitute for the acceleration value to the point value of another disk D.

According to the related configuration, in the case where the error occurrence interval is shorter than the preventive-maintenance period of another disk D in which the recovered error has occurred, the recovered-error control unit 105 adds the two-stage acceleration value as a substitute for the acceleration value to the point value of another disk D. Therefore, the recovered-error control unit 105 can further accelerate the timing of preventive-maintenance of another disk D and thus prevent an unrecovered error from occurring during preventive-maintenance. That is, even in the case where the error occurrence interval until the occurrence of the unrecovered error is shorter than the preventive-maintenance period, the recovered-error control unit 105 can complete preventive-maintenance (redundant copy) before an unrecovered error occurs in another disk D. As a result, the recovered-error control unit 105 can reliably prevent loss of the data of another disk D.

Moreover, in the case where the error occurrence interval is shorter than the preventive-maintenance period of another disk in the same lot group as the disk in which the unrecovered error has occurred, the recovered-error control unit 105 according to the fifth embodiment adds the two-stage acceleration value as a substitute for the acceleration value to the point value of another disk. Then, if the point value reaches the threshold value, the recovered-error control unit 105 sets another disk as a preventive-maintenance subject. However, the recovered-error control unit 105 is not limited thereto. In the same case as described above, the recovered-error control unit 105 may set the number of two-stage acceleration times as a substitute for the number of recovered error occurrences of the disk in which the unrecovered error has occurred, as the upper limit number of recovery times. Then, in the case where the number of recovered error occurrences of another disk in the same lot group as the disk in which the unrecovered error has occurred reaches the upper limit number of recovery times, the recovered-error control unit 105 may set another disk as a preventive-maintenance subject. In this case, the number of two-stage acceleration times is set to a value smaller than the number of recovered error occurrences of the disk in which the unrecovered error has occurred.

### Others

Moreover, each component of each device illustrated does not necessarily need to be physically configured as illustrated. That is, specific embodiments of distribution and integration of the individual devices are not limited to those illustrated, but can be configured by functionally or physically distributing and integrating the whole or part thereof in arbitrary units according to various loads or use situations, etc. For example, the recovered-error control unit 105 and the unrecovered-error control unit 106 may be integrated into one unit. Meanwhile, the unrecovered-error control unit 106 may be distributed into an indicating unit indicating preventive-maintenance acceleration and a converting unit converting a point value of a disk in which a recovered error has already occurred into an acceleration value. Moreover, the storage unit 200 may be an external device of the RAID controller 20 and be connected through a network.

Further, although the RAID device using a disk as a storage device has been described as an example in the above-mentioned embodiments, the disclosed technology is not limited thereto but can be implemented by using an arbitrary recoding medium.

Furthermore, the whole or arbitrary part of each process function performed in the storage device 1 and the RAID device 2 may be implemented by a central processing unit (CPU) (or a micro computer such as a micro processing unit (MPU), a micro controller unit (MCU), etc.) and a program which can be compiled and executed in the CPU (or the micro computer such as the MPU, MCU, etc.), or may be implemented as hardware based on wired logic.

According to an aspect of the storage device discussed here, it is possible to prevent loss of data of a data storage unit belonging to the same attribution group with another data storage unit that contains a defect.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage device comprising:
a plurality of data storage units that store data;
an attribution storage unit that stores an attribution group including each data storage unit on the basis of attributions of the plurality of data storage units;
a defect storage unit that stores defects that occurred in a data storage unit;
a preventive-maintenance-subject extracting unit that extracts, as a preventive-maintenance subject, another data storage unit belonging to the same attribution group as the data storage unit in which the defects stored by the defect storage unit has occurred, on the basis of an occurrence history of the defects that occurred in the data storage unit and the attribution group stored by the attribution group storage unit; and
a preventive-maintenance performing unit that performs preventive-maintenance on data stored in the other data storage unit extracted by the preventive-maintenance-subject extracting unit.

2. The storage device according to claim 1, wherein the preventive-maintenance-subject extracting unit measures the number of defect occurrences based on a predetermined factor until a defect becoming a factor of immediate cutoff has occurred in the data storage unit in which the defects have occurred, and extracts the other data storage unit as the preventive-maintenance subject if the number of defect occurrences of the other data storage unit based on the predetermined factor reaches the measured number of defect occurrences based on the predetermined factor.

3. The storage device according to claim 2, wherein the preventive-maintenance-subject extracting unit includes
a defect occurrence interval calculating unit that calculates a defect occurrence interval from when the measured number of defect occurrences was reached to when the defect becoming the factor of immediate cutoff has occurred, with respect to the data storage unit in which the defects has occurred,
a defect occurrence interval determining unit that determines whether the defect occurrence interval calculated by the defect occurrence interval calculating unit is shorter than a preventive-maintenance period necessary for preventive-maintenance on the other data storage unit, and
in the case where the defect occurrence interval determining unit determines that the defect occurrence interval is shorter than the preventive-maintenance period, the predetermined number of defect occurrences, based on the predetermined factor, of the other data storage unit is changed.

4. The storage device according to claim 2, further comprising:
a RAID group storage unit that stores a RAID group including the plurality of data storage units,
wherein the preventive-maintenance-subject extracting unit extracts the other data storage unit in which the defect based on the predetermined factor has occurred, as a preventive-maintenance subject, on the basis of an occurrence history of defects based on the predetermined factor measured for each RAID group.

5. The storage device according to claim 1, wherein, if a defect becoming a factor of immediate cutoff occurs in the data storage unit in which the defects have occurred, when a defect based on the predetermined factor occurs in the other data storage unit, the preventive-maintenance-subject extracting unit adds a second score larger than a first score as a substitute for the first score to a point value of the other data storage unit, and extracts the other data storage unit as a preventive-maintenance subject if the added point value reaches a threshold value.

6. The storage device according to claim 5, wherein, in the case where a defect based on the predetermined factor has occurred in the other data storage unit before a defect becoming a factor of immediate cutoff occurs in the data storage unit in which the defects have occurred, the preventive-maintenance-subject extracting unit converts the point value of the other data storage unit into the second score, and extracts the other data storage unit as a preventive-maintenance subject if the converted point value reaches the threshold value.

7. A controller of a storage device, comprising:
an attribution storage unit that stores an attribution group including each data storage unit on the basis of attributions of a plurality of data storage units that store data;
a defect storage unit that stores defects that occurred in a data storage unit;
a preventive-maintenance-subject extracting unit that extracts, as a preventive-maintenance subject, another data storage unit belonging to the same attribution group as the data storage unit in which the defects stored by the defect storage unit has occurred, on the basis of an occurrence history of the defects that occurred in the data storage unit and the attribution group stored by the attribution group storage unit; and
a preventive-maintenance performing unit that performs preventive-maintenance on data stored in the other data storage unit extracted by the preventive-maintenance-subject extracting unit.

8. A method of controlling preventive-maintenance on a plurality of data storage units by a storage device that includes the data storage units, the method comprising:
storing an attribution group including each data storage unit on the basis of attributions of the plurality of data storage units storing data;
storing defects that occurred in a data storage unit;
extracting, as a preventive-maintenance subject, another data storage unit belonging to the same attribution group as the data storage unit in which the defects stored by the defect storage unit have occurred, on the basis of an occurrence history of the defects that occurred in the data storage unit and the attribution group stored by the storing of the attribution group; and
performing preventive-maintenance on data stored in the other data storage unit extracted by the extracting of the preventive-maintenance subject.
